(19) United States
(12) Patent Application Publication
(10) Pub. No.: US 2018/0019072 A1
(43) Pub. Date: Jan. 18, 2018

(54) Electrochemical Method of Producing Graphene-Based Supercapacitor Electrode from Coke or Coal

(71) Applicant: Nanotek Instuments, Inc., Dayton, OH (US)

(72) Inventors: Aruna Zhamu, Springboro, OH (US); Bor Z. Jang, Centerville, OH (US)

(73) Assignee: Nanotek Instuments, Inc., Dayton, OH (US)

(21) Appl. No.: 15/211,727

(22) Filed: Jul. 15, 2016

(51) Int. Cl. H01G 11/86; B28B 1/50; B05D 1/30; B28B 3/02; C25B 1/00; B28B 17/02

(52) U.S. Cl. CPC H01G 11/86; C25B 1/00; B28B 17/02; B05D 1/30; B28B 3/02; B28B 1/50; C01P 2006/40

(57) ABSTRACT

A method of producing graphene sheets from coke or coal powder, comprising: (a) forming an intercalated coke or coal compound by electrochemical intercalation conducted in an intercalation reactor, which contains (i) a liquid solution electrolyte comprising an intercalating agent; (ii) a working electrode that contains the powder in ionic contact with the liquid electrolyte, wherein the coke or coal powder is selected from petroleum coke, coal-derived coke, meso-phase coke, synthetic coke, leonardite, lignite coal, or natural coal mineral powder; and (iii) a counter electrode in ionic contact with the electrolyte, and wherein a current is imposed upon the working electrode and the counter electrode for effecting electrochemical intercalation of the intercalating agent into the powder; and (b) exfoliating and separating graphene planes from the intercalated coke or coal compound using an ultrasonication, thermal shock exposure, mechanical shearing treatment, or a combination thereof to produce isolated graphene sheets.

### FIELD OF THE INVENTION

The present invention relates to an electrochemical process for producing a graphene-based supercapacitor electrode directly from natural coal or coal derivatives (e.g. needle coke).

### BACKGROUND

Electrochemical capacitors (ECs), also known as ultracapacitors or supercapacitors, are being considered for uses in hybrid electric vehicles (EVs) where they can supplement a battery used in an electric car to provide bursts of power needed for rapid acceleration, the biggest technical hurdle to making battery-powered cars commercially viable. A battery would still be used for cruising, but supercapacitors (with their ability to release energy much more quickly than batteries) would kick in whenever the car needs to accelerate for merging, passing, emergency maneuvers, and hill climbing. The EC must also store sufficient energy to provide an acceptable driving range. To be cost-, volume-, and weight-effective compared to additional battery capacity they must combine adequate energy densities (volumetric and gravimetric) and power densities (volumetric and gravimetric) with long cycle life, and meet cost targets as well.

ECs are also gaining acceptance in the electronics industry as system designers become familiar with their attributes and benefits. ECs were originally developed to provide large bursts of driving energy for orbital lasers. In complementary metal oxide semiconductor (CMOS) memory backup applications, for instance, a one-Farad EC having a volume of only one-half cubic inch can replace nickel-cadmium or lithium batteries and provide backup power for months. For a given applied voltage, the stored energy in an EC associated with a given charge is half that storable in a corresponding battery system for passage of the same charge. Nevertheless, ECs are extremely attractive power sources. Compared with batteries, they require no maintenance, offer much higher cycle-life, require a very simple charging circuit, experience no “memory effect,” and are generally much safer. Physical rather than chemical energy storage is the key reason for their safe operation and extraordinarily high cycle-life. Perhaps most importantly, capacitors offer higher power density than batteries.

The high volumetric capacitance density of an EC relative to conventional capacitors (10 to 100 times greater than conventional capacitors) derives from using porous electrodes to create a large effective “plate area” and from storing energy in the diffuse double layer. This double layer, created naturally at a solid-electrolyte interface when voltage is imposed, has a thickness of only about 1 nm, thus forming an extremely small effective “plate separation.” Such a supercapacitor is commonly referred to as an electric double layer capacitor (EDLC). The double layer capacitor is based on a high surface area electrode material, such as activated carbon, immersed in a liquid electrolyte. A polarized double layer is formed at electrode-electrolyte interfaces providing high capacitance. This implies that the specific capacitance of a supercapacitor is directly proportional to the specific surface area of the electrode material. This surface area must be accessible by electrolyte and the resulting interfacial zones must be sufficiently large to accommodate the so-called electric double-layer charges.

In some ECs, stored energy is further augmented by pseudo-capacitance effects, occurring again at the solid-electrolyte interface due to electrochemical phenomena such as the redox charge transfer. Such a supercapacitor is commonly referred to as a pseudo-capacitor or redox supercapacitor. A third type of supercapacitor is a lithium-ion capacitor that contains a pre-lithiated graphite anode, an EDLC cathode (e.g. typically based on activated carbon particles), and a lithium salt electrolyte.

However, there are several serious technical issues associated with current state-of-the-art supercapacitors:
(1) Experience with supercapacitors based on activated carbon electrodes shows that the experimentally measured capacitance is always much lower than the geometrical capacitance calculated from the measured surface area and the width of the dipole layer. For very high surface area activated carbons, typically only about 20-40 percent of the “theoretical” capacitance was observed. This disappointing performance is related to the presence of micro-pores (<2 nm, mostly <1 nm) and ascribed to inaccessibility of some pores by the electrolyte, wetting deficiencies, and/or the inability of a double layer to form successfully in pores in which the oppositely charged surfaces are less than about 1-2 nm apart. In activated carbons, depending on the source of the carbon and the heat treatment temperature, a surprising amount of surfaces can be in the form of such micro-pores that are not accessible to liquid electrolyte.
(2) Despite the high gravimetric capacitances at the electrode level (based on active material weights alone) as frequently claimed in open literature and patent documents, these electrodes unfortunately fail to provide energy storage devices with high capacities at the supercapacitor cell or pack level (based on the total cell weight or pack weight). This is due to the notion that, in these reports, the actual mass loadings of the electrodes and the apparent densities for the active materials are too low. In most cases, the active material mass loadings of the electrodes (areal density) is significantly lower than 10 mg/cm² (areal density=the amount of active materials per electrode cross-sectional area along the electrode thickness direction) and the apparent volume density or tap density of the active material is typically less than 0.75 g/cm³ (more typically less than 0.5 g/cm³ and most typically less than 0.3 g/cm³) even for relatively large particles of activated carbon.

The low mass loading is primarily due to the inability to obtain thicker graphene-based electrodes (thicker than 100 μm) using the conventional slurry coating procedure. This is not a trivial task as one might think, and in reality the electrode thickness is not a design parameter that can be arbitrarily and freely varied for the purpose of optimizing the cell performance. Contrarily, thicker electrodes tend to become extremely brittle or of poor structural integrity and would also require the use of large amounts of binder resin. These problems are particularly acute for graphene material-based electrodes. It has not been previously possible to produce graphene-based electrodes that are thicker than 100 μm and remain highly porous with pores remaining fully accessible to liquid electrolyte. The low areal densities and low volume densities (related to thin electrodes and poor packing density) result in relatively low volumetric capacitances and low volumetric energy density of the supercapacitor cells.

With the growing demand for more compact and portable energy storage systems, there is keen interest to increase the utilization of the volume of the energy storage devices. Novel electrode materials and designs that enable high volumetric capacitances and high mass loadings are essential to achieving improved cell volumetric capacitances and energy densities.
(3) During the past decade, much work has been conducted to develop electrode materials with increased volumetric capacitances utilizing porous carbon-based materials, such as graphene, carbon nanotube-based composites, porous graphite oxide, and porous meso carbon.

Although these experimental supercapacitors featuring such electrode materials can be charged and discharged at high rates and also exhibit large volumetric electrode capacitances (50 to 150 F/cm³ in most cases, based on the electrode volume), their typical active mass loading of <1 mg/cm², tap density of <0.2 g/cm³, and electrode thicknesses of up to tens of micrometers (<<100 μm) are still significantly lower than those used in most commercially available electrochemical capacitors (i.e. 10 mg/cm², 100-200 μm), which results in energy storage devices with relatively low areal and volumetric capacitances and low volumetric energy densities.
(4) For graphene-based supercapacitors, there are additional problems that remain to be solved, explained below:

Graphene exhibits exceptionally high thermal conductivity, high electrical conductivity, high strength, and exceptionally high specific surface area. A single graphene sheet provides a specific external surface area of approximately 2,675 m²/g (that is accessible by liquid electrolyte), as opposed to the exterior surface area of approximately 1,300 m²/g provided by a corresponding single-wall CNT (interior surface not accessible by electrolyte). The electrical conductivity of graphene is slightly higher than that of CNTs.

The instant applicants (A. Zhamu and B. Z. Jang) and their colleagues were the first to investigate graphene- and other nano graphite-based nano materials for supercapacitor application [Please see Refs. 1-5 below; the 1^{st} patent application was submitted in 2006 and issued in 2009]. After 2008, researchers began to realize the significance of graphene materials for supercapacitor applications.

### LIST OF REFERENCES

1. Lulu Song, A. Zhamu, Jiusheng Guo, and B. Z. Jang “Nano-scaled Graphene Plate Nanocomposites for Supercapacitor Electrodes” U.S. Pat. No. 7,623,340 (Nov. 24, 2009).
2. Aruna Zhamu and Bor Z. Jang, “Process for Producing Nano-scaled Graphene Platelet Nanocomposite Electrodes for Supercapacitors,” U.S. patent application Ser. No. 11/906,786 (Oct. 4, 2007).
3. Aruna Zhamu and Bor Z. Jang, “Graphite-Carbon Composite Electrodes for Supercapacitors” U.S. patent application Ser. No. 11/895,657 (Aug. 27, 2007).
4. Aruna Zhamu and Bor Z. Jang, “Method of Producing Graphite-Carbon Composite Electrodes for Supercapacitors” U.S. patent application Ser. No. 11/895,588 (Aug. 27, 2007).
5. Aruna Zhamu and Bor Z. Jang, “Graphene Nanocomposites for Electrochemical cell Electrodes,” U.S. patent application Ser. No. 12/220,651 (Jul. 28, 2008).

However, individual nano graphene sheets have a great tendency to re-stack themselves, effectively reducing the specific surface areas that are accessible by the electrolyte in a supercapacitor electrode. The significance of this graphene sheet overlap issue may be illustrated as follows: For a nano graphene platelet with dimensions of l (length)×w (width)×t (thickness) and density ρ, the estimated surface area per unit mass is S/m=(2/ρ)(1/l+1/w+1/t). With ρ≅2.2 g/cm³, l=100 nm, w=100 nm, and t=0.34 nm (single layer), we have an impressive S/m value of 2,675 m²/g, which is much greater than that of most commercially available carbon black or activated carbon materials used in the state-of-the-art supercapacitor. If two single-layer graphene sheets stack to form a double-layer graphene, the specific surface area is reduced to 1,345 m²/g. For a three-layer graphene, t=1 nm, we have S/m=906 m²/g. If more layers are stacked together, the specific surface area would be further significantly reduced.

These calculations suggest that it is critically important to find a way to prevent individual graphene sheets from re-stacking and, even if they partially re-stack, the resulting multi-layer structure would still have inter-layer pores of adequate sizes. These pores must be sufficiently large to allow for accessibility by the electrolyte and to enable the formation of electric double-layer charges, which presumably require a pore size of at least 1-2 nm. However, these pores or inter-graphene spacings must also be sufficiently small to ensure a large tap density (hence, large capacitance per unit volume or large volumetric energy density). Unfortunately, the typical tap density of graphene-based electrode produced by the conventional process is less than 0.3 g/cm³, and most typically <<0.2 g/cm³. To a great extent, the requirement to have large pore sizes and high porosity level and the requirement to have a high tap density are considered mutually exclusive in supercapacitors.

Another major technical barrier to using graphene sheets as a supercapacitor electrode active material is the challenge of forming a thick active material layer onto the surface of a solid current collector (e.g. Al foil) using the conventional graphene-solvent slurry coating process. In such an electrode, the graphene electrode typically requires a large amount of a binder resin (hence, significantly reduced active material proportion vs. non-active or overhead materials/components). In addition, any graphene electrode prepared in this manner that is thicker than 50 μm is brittle and weak. There has been no effective solution to these problems.

Therefore, there is clear and urgent need for supercapacitors that have high active material mass loading (high areal density), active materials with a high apparent density (high tap density), high electrode thickness, high volumetric capacitance, and high volumetric energy density. For graphene-based electrodes, one must also overcome problems such as re-stacking of graphene sheets, the demand for large proportion of a binder resin, and difficulty in producing thick graphene electrode layers.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene 5% by weight of oxygen), graphene oxide (≧5% by weight of oxygen), slightly fluorinated graphene 5% by weight of fluorine), graphene fluoride ((≧5% by weight of fluorine), other halogenated graphene, and chemically functionalized graphene.

NGPs have been found to have a range of unusual physical, chemical, and mechanical properties. For instance, graphene was found to exhibit the highest intrinsic strength and highest thermal conductivity of all existing materials. Although practical electronic device applications for graphene (e.g., replacing Si as a backbone in a transistor) are not envisioned to occur within the next 5-10 years, its application as a nano filler in a composite material and an electrode material in energy storage devices is imminent. The availability of graphene sheets in large quantities is essential to the success in exploiting composite, energy, and other applications for graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were reviewed by us [Bor Z. Jang and A. Zhamu, “Processing of Nano Graphene Platelets (NGPs) and NGP Nanocomposites: A Review,” J. Materials Sci. 43 (2008) 5092-5101]. Four main prior-art approaches have been followed to produce NGPs. Their advantages and shortcomings are briefly summarized as follows:

### Approach 1: Chemical Formation and Reduction of Graphite Oxide (GO) Platelets

The first approach entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½ d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded (i.e. oxidized and/or intercalated graphite) or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

There are several major problems associated with this conventional chemical production process:
(1) The process requires the use of large quantities of several undesirable chemicals, such as sulfuric acid, nitric acid, and potassium permanganate or sodium chlorate.
(2) The chemical treatment process requires a long intercalation and oxidation time, typically 5 hours to five days.
(3) Strong acids consume a significant amount of graphite during this long intercalation or oxidation process by “eating their way into the graphite” (converting graphite into carbon dioxide, which is lost in the process). It is not unusual to lose 20-50% by weight of the graphite material immersed in strong acids and oxidizers.
(4) Both heat- and solution-induced exfoliation approaches require a very tedious washing and purification step. For instance, typically 2.5 kg of water is used to wash and recover 1 gram of GIC, producing huge quantities of waste water that need to be properly treated.
(5) In both the heat- and solution-induced exfoliation approaches, the resulting products are GO platelets that must undergo a further chemical reduction treatment to reduce the oxygen content. Typically even after reduction, the electrical conductivity of GO platelets remains much lower than that of pristine graphene. Furthermore, the reduction procedure often involves the utilization of toxic chemicals, such as hydrazine.
(6) Furthermore, the quantity of intercalation solution retained on the flakes after draining may range from 20 to 150 parts of solution by weight per 100 parts by weight of graphite flakes (pph) and more typically about 50 to 120 pph.
(7) During the high-temperature exfoliation, the residual intercalate species (e.g. sulfuric acid and nitric acid) retained by the flakes decompose to produce various species of sulfuric and nitrous compounds (e.g., NOₓ and SOₓ), which are undesirable. The effluents require expensive remediation procedures in order not to have an adverse environmental impact.
   The present invention was made to overcome the limitations outlined above.

### Approach 2: Direct Formation of Pristine Nano Graphene Sheets

In 2002, our research team succeeded in isolating single-layer and multi-layer graphene sheets from partially carbonized or graphitized polymeric carbons, which were obtained from a polymer or pitch precursor [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. Mack, et al [“Chemical manufacture of nanostructured materials” U.S. Pat. No. 6,872,330 (Mar. 29, 2005)] developed a process that involved intercalating natural graphite with potassium metal melt and contacting the resulting K-intercalated graphite with alcohol, producing violently exfoliated graphite containing NGPs. The process must be carefully conducted in a vacuum or an extremely dry glove box environment since pure alkali metals, such as potassium and sodium, are extremely sensitive to moisture and pose an explosion danger. This process is not amenable to the mass production of NGPs. The present invention was made to overcome the limitations outlined above.

### Approach 3: Epitaxial Growth and Chemical Vapor Deposition of Nano Graphene Sheets on Inorganic Crystal Surfaces

Small-scale production of ultra-thin graphene sheets on a substrate can be obtained by thermal decomposition-based epitaxial growth and a laser desorption-ionization technique. [Walt A. DeHeer, Claire Berger, Phillip N. First, “Patterned thin film graphite devices and method for making same” U.S. Pat. No. 7,327,000 B2 (Jun. 12, 2003)] Epitaxial films of graphite with only one or a few atomic layers are of technological and scientific significance due to their peculiar characteristics and great potential as a device substrate. However, these processes are not suitable for mass production of isolated graphene sheets for composite materials and energy storage applications.

Approach 4: The Bottom-Up Approach (Synthesis of Graphene from Small Molecules)

Yang, et al. [“Two-dimensional Graphene Nano-ribbons,” J. Am. Chem. Soc. 130 (2008) 4216-17] synthesized nano graphene sheets with lengths of up to 12 nm using a method that began with Suzuki-Miyaura coupling of 1,4-diiodo-2,3,5,6-tetraphenyl-benzene with 4-bromophenylboronic acid. The resulting hexaphenylbenzene derivative was further derivatized and ring-fused into small graphene sheets. This is a slow process that thus far has produced very small graphene sheets.

Hence, an urgent need exists to have a graphene production process that requires a reduced amount of undesirable chemicals (or elimination of these chemicals all together), shortened process time, less energy consumption, lower degree of graphene oxidation, reduced or eliminated effluents of undesirable chemical species into the drainage (e.g., sulfuric acid) or into the air (e.g., SO₂ and NO₂). The process should be able to produce more pristine (less oxidized and less damaged), more electrically conductive, and larger/wider graphene sheets.

Furthermore, most of the prior art processes for graphene production begin with the use of highly purified natural graphite as the starting material. The purification of graphite ore involves the use of large amounts of undesirable chemicals. Clearly, a need exists to have a more cost-effective process that produces graphene sheets (particularly single-layer graphene and few-layer graphene sheets) directly from coal or coal derivatives and readily converts the graphene sheets into a porous supercapacitor electrode. Such a process not only avoids the environment-polluting graphite ore purification procedures but also makes it possible to have low-cost graphene available. As of today, the graphene, as an industry, has yet to emerge mainly due to the extremely high graphene costs that have thus far prohibited graphene-based products from being widely accepted in the marketplace.

A further object of the present invention is a process for producing graphene-based supercapacitor electrode that has an active material mass loading higher than 10 mg/cm², preferably higher than 20 mg/cm², and more preferably higher than 30 mg/cm².

### SUMMARY OF THE INVENTION

The present invention provides a method of producing graphene-based supercapacitor electrodes sheets having an average thickness smaller than 10 nm (preferably and typically single-layer graphene or few-layer graphene) directly from a coke or coal powder having hexagonal carbon atomic interlayers (graphene planes or graphene domains) with an interlayer spacing (inter-graphene plane spacing). The method comprises:
(a) forming an intercalated coke or coal compound by an electrochemical intercalation procedure which is conducted in an intercalation reactor, wherein the reactor contains (i) a liquid solution electrolyte comprising an intercalating agent; (ii) a working electrode that contains the coke (including needle coke from petroleum or coal sources) or coal powder as an active material in ionic contact with said liquid solution electrolyte, wherein said coke or coal powder is selected from petroleum coke, coal-derived coke, meso-phase coke, synthetic coke, leonardite, anthracite coal, lignite coal, bituminous coal, natural coal mineral powder (e.g. including any coal or coke powder that either has never been previously heat-treated at a temperature above 1,500° C. or has been graphitized at a graphitization temperature above 1,500° C.), or a combination thereof; and (iii) a counter electrode in ionic contact with the liquid solution electrolyte, and wherein a current is imposed upon the working electrode and the counter electrode at a current density for a duration of time sufficient for effecting electrochemical intercalation of the intercalating agent into the interlayer spacing; and
(b) exfoliating and separating said hexagonal carbon atomic interlayers from the intercalated coke or coal compound using an ultrasonication, thermal shock exposure, mechanical shearing treatment, or a combination thereof to produce the isolated graphene sheets, which are produced in a liquid medium to form a graphene suspension (dispersion);
(c) shaping or shaping and drying the graphene suspension into the supercapacitor electrode that is porous and has a specific surface area greater than 200 m²/g. The supercapacitor electrode is preferably in a paper sheet, porous film, porous filament, porous rod, or porous tube form.

Preferably, particles of the coke or coal powder have never been previously intercalated or oxidized prior to step (a). In some embodiments, multiple particles of the coke or coal powder are dispersed in the liquid solution electrolyte, disposed in a working electrode compartment, and supported or confined by a current collector in electronic contact therewith, and wherein the working electrode compartment and these multiple particles supported thereon or confined therein are not in electronic contact with the counter electrode. Preferably, these multiple particles of coke (e.g. needle coke) or coal are clustered together to form a network of electron-conducting pathways.

In some embodiments, the reactor further contains a graphene plane-wetting agent dissolved in the liquid solution electrolyte. Preferably, the graphene plane-wetting agent is selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid, 1-pyrenebutyric acid, 1-pyrenamine, poly(sodium-4-styrene sulfonate), or a combination thereof. This agent is surprisingly found to be very effective in promoting electrochemical intercalation, exfoliation, and/or separation of graphene sheets.

The method may be practiced by following a process that is conducted intermittently or continuously and the supply of coke or coal powder and the liquid solution electrolyte are provided into the reactor intermittently or continuously. In some embodiments, the coke or coal powder in the working electrode compartment is dispersed in the liquid solution electrolyte at a concentration higher than 20% by weight. In some embodiments, the coke or coal powder in the working electrode compartment is dispersed in the liquid solution electrolyte at a concentration higher than 50% by weight.

In the invented method, the mechanical shearing treatment may comprise operating air milling, air jet milling, ball milling, rotating-blade mechanical shearing, or a combination thereof. In some embodiments, the imposing current provides a current density in the range of 0.1 to 600 A/m², preferably in the range of 1 to 500 A/m², and further preferably in the range of 10 to 300 A/m².

In some embodiments, the thermal shock exposure comprises heating said intercalated coke or coal compound to a temperature in the range of 300-1,200° C. for a period of 15 seconds to 2 minutes.

In some embodiments, the isolated graphene sheets contain single-layer graphene, or few-layer graphene having 2-10 hexagonal carbon atomic interlayers or graphene planes.

In some embodiments, the electrochemical intercalation includes intercalation of both an intercalating agent and a wetting agent into the interlayer spacing.

In some embodiments, the method further comprises a step of re-intercalating the isolated graphene sheets (if not single-layer graphene sheets) using an electrochemical or chemical intercalation method to obtain intercalated graphene sheets and a step of exfoliating and separating the intercalated graphene sheets to produce single-layer graphene sheets using ultrasonication, thermal shock exposure, exposure to water solution, mechanical shearing treatment, or a combination thereof.

In some embodiments, the intercalating agent includes a species selected from a Brønsted acid selected from phosphoric acid (H₃PO₄), dichloroacetic (Cl₂CHCOOH), or an alkylsulfonic acid selected from methanesulfonic (MeSO₃H), ethanesulfonic (EtSO₃H), or 1-propanesulfonic (n-PrSO₃H), or a combination thereof. The intercalating agent can include a metal halide.

In some embodiments, the intercalating agent includes a metal halide selected from the group consisting of MCl (M=Li, Na, K, Cs), MCl₂ (M=Zn, Ni, Cu, Mn), MCl₃ (M=Al, Fe, Ga), MCl₄ (M=Zr, Pt), MF₂ (M=Zn, Ni, Cu, Mn), MF₃ (M=Al, Fe, Ga), MF₄ (M=Zr, Pt), and combinations thereof.

In some preferred embodiments, the intercalating agent includes an alkali metal salt selected from lithium perchlorate (LiClO₄), sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a sodium ionic liquid salt, lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The intercalating agent may include an organic solvent selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), propylene carbonate (PC), dimethyl carbonate (DMC), methylethyl carbonate (MEC), diethyl carbonate (DEC), ethyl propionate, methyl propionate, gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofloroether, or a combination thereof.

In the invented method, preferably the intercalating agent includes an alkali metal salt selected from the above list and the liquid medium contains a solvent having the alkali metal salt dissolved in the solvent to form a liquid electrolyte. Further, step (c) includes subjecting the graphene suspension to a forced assembly procedure, forcing the graphene sheets to assemble into an electrolyte-impregnated laminar graphene structure, wherein the multiple graphene sheets are alternately spaced by thin electrolyte layers, having a thickness from 0.4 nm to 10 nm, and the multiple graphene sheets are substantially aligned along a desired direction, and wherein the laminar graphene structure has a physical density from 0.5 to 1.7 g/cm³ and a specific surface area from 50 to 3,300 m²/g, when measured in a dried state of the laminar structure with the electrolyte removed.

A surprising advantage of this method is the notion that substantially the same electrolyte used in the electrochemical intercalation of coal/coke powder for the production of graphene sheets form the graphene suspension that is used in the subsequent forced assembly procedure.

In certain embodiments, the liquid medium contains an organic solvent and an alkali metal dissolved in the organic solvent to form a liquid electrolyte, and step (c) includes subjecting the graphene suspension to a forced assembly procedure, forcing the graphene sheets to assemble into an electrolyte-impregnated laminar graphene structure, wherein the multiple graphene sheets are alternately spaced by thin electrolyte layers, having a thickness from 0.4 nm to 10 nm, and the multiple graphene sheets are substantially aligned along a desired direction, and wherein the laminar graphene structure has a physical density from 0.5 to 1.7 g/cm³ and a specific surface area from 50 to 3,300 m²/g, when measured in a dried state of the laminar structure with the electrolyte being removed. Preferably, the alkali metal salt may be selected from the aforementioned list.

In certain embodiments, the forced assembly procedure includes introducing the graphene suspension, having an initial volume V₁, in a mold cavity cell and driving a piston into the mold cavity cell to reduce the graphene dispersion volume to a smaller value V₂, allowing excess electrolyte to flow out of the cavity cell and aligning the multiple graphene sheets along a desired direction.

In some preferred embodiments, the forced assembly procedure includes introducing the graphene dispersion in a mold cavity cell having an initial volume V₁, and applying a suction pressure through a porous wall of the mold cavity to reduce the graphene dispersion volume to a smaller value V₂, allowing excess electrolyte to flow out of the cavity cell through said porous wall and aligning the multiple graphene sheets along a desired direction.

In some other preferred embodiments, the forced assembly procedure includes introducing a first layer of graphene suspension (dispersion) onto a surface of a supporting conveyor and driving the layer of graphene suspension supported on the conveyor through at least a pair of pressing rollers to reduce the thickness of the graphene dispersion layer and align the multiple graphene sheets along a direction parallel to the conveyor surface for forming a layer of electrolyte-impregnated laminar graphene structure.

Preferably, this method further includes a step of introducing a second layer of the graphene dispersion onto a surface of the layer of electrolyte-impregnated laminar graphene structure to form a two layer laminar structure, and driving the two-layer laminar structure through at least a pair of pressing rollers to reduce the thickness of the second layer of graphene dispersion and align the multiple graphene sheets along a direction parallel to the conveyor surface for forming a layer of electrolyte-impregnated laminar graphene structure.

The method may further include a step of compressing or roll-pressing the electrolyte-impregnated laminar structure to reduce the thin electrolyte layer thickness in the impregnated laminar structure, improve orientation of graphene sheets, and squeeze excess electrolyte out of the impregnated laminar graphene structure for forming the supercapacitor electrode.

Preferably, this method is accomplished by using a roll-to-roll process wherein the forced assembly procedure includes feeding the supporting conveyor, in a continuous film form, from a feeder roller to a deposition zone, continuously or intermittently depositing the graphene dispersion onto a surface of the supporting conveyor film to form the layer of graphene dispersion thereon, and collecting the layer of electrolyte-impregnated laminar graphene structure supported on conveyor film on a collector roller.

In some preferred embodiments, a desired amount of a foaming agent is added into the graphene suspension and step (c) of the invented process includes depositing the graphene suspension onto a surface of a solid substrate to form a wet graphene film under the influence of a shear stress or compressive stress to align the graphene sheets parallel to the substrate surface, and wherein the wet film is dried and heated to form a porous dry graphene film. The wet graphene film or dry graphene film may be subjected to a heat treatment at a temperature from 100° C. to 3,200° C.

In some preferred embodiments, a desired amount of a foaming agent is added into the graphene suspension and step (c) includes shaping the graphene suspension using a procedure of casting, coating, spraying, printing, extrusion, fiber spinning, or a combination thereof.

The step of shaping and drying said graphene suspension comprises dispensing the suspension onto a surface or two surfaces of a current collector to form said electrode in a film form having a thickness from 1 μm to 1,000 μm.

The step of shaping and drying the graphene suspension comprises dispensing and heat treating the suspension to form a layer of graphene foam having a thickness from 1 μm to 1,000 μm. Alternatively, the step of shaping and drying the graphene suspension comprises freeze-drying the suspension to form a graphene foam electrode.

The process typically enables the supercapacitor electrode to achieve an active material mass loading higher than 10 mg/cm², more typically higher than 20 mg/cm², and even more typically higher than 30 mg/cm².

### BRIEF DESCRIPTION OF THE DRAWINGS

FIG. 1 A flow chart showing an embodiment of the presently invented method of producing isolated graphene sheets.

FIG. 2 Schematic drawing of an apparatus for electrochemical intercalation of coal or coke.

FIG. 3 Schematic of a conventional activated carbon-based supercapacitor cell.

FIG. 4(A) Schematic drawing to illustrate an example of a compressing and consolidating operation (using a mold cavity cell equipped with a piston or ram) for forming a layer of highly compacted and oriented graphene sheets. Graphene sheets are aligned parallel to the bottom plane or perpendicular to the layer thickness direction.

FIG. 4(B) Schematic drawing to illustrate another example of a compressing and consolidating operation (using a mold cavity cell equipped with a piston or ram) for forming a layer of highly compacted and oriented graphene sheets. Graphene sheets are aligned perpendicular to the side plane (X-Y plane) or parallel to the layer thickness direction (Z direction).

FIG. 4(C) Schematic drawing to illustrate yet another example of a compressing and consolidating operation (using a mold cavity cell with a vacuum-assisted suction provision) for forming a layer of highly compacted and oriented graphene sheets. Graphene sheets are aligned parallel to the bottom plane or perpendicular to the layer thickness direction. Preferably, the resulting layer of electrolyte-impregnated laminar graphene structure is further compressed to achieve an even high tap density.

FIG. 4(D) A roll-to-roll process for producing a thick layer of electrolyte-impregnated laminar graphene structure. Graphene sheets are well-aligned on the supporting substrate plane.

FIG. 5 Ragone plots of two symmetric supercapacitors (EDLCs), one prepared by the instant method and the other by a prior art method.

FIG. 6 Ragone plots of two lithium-ion capacitors (LICs), one prepared by the instant method and the other by a prior art method.

FIG. 7 Ragone plots of two sodium-ion capacitors (NICs), one prepared by the instant method and the other by a prior art method. Each NIC contains pre-sodiated needle coke particles as the anode active material and needle coke-derived graphene sheets as the cathode active material.

### DETAILED DESCRIPTION OF PREFERRED EMBODIMENTS

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In the case of a carbon or graphite fiber segment, the graphene plates may be a part of a characteristic “turbostratic structure.”

Basically, a graphite material is composed of many graphene planes (hexagonal carbon atomic interlayers) stacked together having inter-planar spacing. These graphene planes can be exfoliated and separated to obtain isolated graphene sheets that can each contain one graphene plane or several graphene planes of hexagonal carbon atoms. Further, natural graphite refers to a graphite material that is produced from purification of graphite mineral (mined graphite ore or graphite rock) typically by a series of flotation and acid treatments. Particles of natural graphite are then subjected to intercalation/oxidation, expansion/exfoliation, and separation/isolation treatments as discussed in the Background section. The instant invention obviates the need to go through the graphite purification procedures that otherwise generate great amounts of polluting chemicals. In fact, the instant invention avoids the use of natural graphite all together as a starting material for the production of graphene sheets. Instead, we begin with coal and its derivatives (including coke, particularly needle coke). No undesirable chemicals, such as concentrated sulfuric acid, nitric acid, and potassium permanganate, are used in the presently invented method.

One preferred specific embodiment of the present invention is a method of producing isolated graphene sheets, also called nano graphene platelets (NGPs), directly from coal powder without purification and then made these graphene sheets into a supercapacitor electrode. We have surprisingly discovered that powder of coal (e.g. leonardite or lignite coal) contains therein graphene-like domains or aromatic molecules that span from 5 nm to 1 μm in length or width. These graphene-like domains contain planes of hexagonal carbon atoms and/or hexagonal carbon atomic interlayers with an interlayer spacing. These graphene-like planes or molecules or interlayers are typically interconnected with disordered chemical groups containing typically C, O, N, P, and/or H. The presently invented method is capable of intercalating, exfoliating, and separating the interlayers and/or separating graphene-like planes or domains from the surrounding disordered chemical species to obtain isolated graphene sheets.

Each graphene sheet comprises one or multiple planes of two-dimensional hexagonal structure of carbon atoms. Each graphene sheet has a length and a width parallel to the graphene plane and a thickness orthogonal to the graphene plane. By definition, the thickness of an NGP is 100 nanometers (nm) or smaller (more typically <10 nm and most typically and desirably <3.4 nm, with a single-sheet NGP (single-layer graphene) being as thin as 0.34 nm. The length and width of a NGP are typically between 5 nm and 10 μm, but could be longer or shorter. Generally, the graphene sheets produced from the coal or coke powder using the presently invented method are single-layer graphene or few-layer graphene (2-10 graphene planes stacked together).

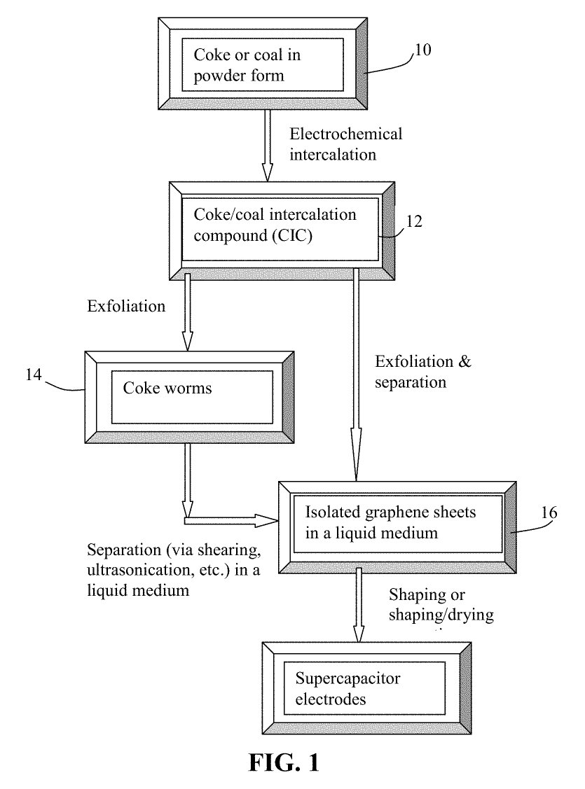

Generally speaking, as schematically shown in FIG. 1, a method has been developed for converting a coke or coal powder 10 to isolated graphene sheets 16 having an average thickness smaller than 10 nm, more typically smaller than 5 nm, and further more typically thinner than 3.4 nm (in many cases, mostly single-layer graphene). The method comprises (a) forming an intercalated coke or coal compound 12 by an electrochemical intercalation procedure conducted in a reactor, which contains (i) a liquid solution electrolyte containing an intercalating agent and a graphene plane-wetting agent dissolved therein; (ii) a working electrode (e.g. anode) comprising multiple particles of coal or coke powder 10 immersed in the liquid solution electrolyte; and (iii) a counter electrode (e.g. a cathode comprising a metal or graphite rod) and wherein a current is imposed upon the working electrode and the counter electrode at a current density for a duration of time sufficient for effecting the electrochemical intercalation; and (b) exposing the intercalated coke or coal compound 12 to a thermal shock, a water solution exposure, and/or an ultrasonication (or other mechanical shearing) treatment.

In this Step (b), thermal shock exposure may be conducted if some organic species have been intercalated into inter-graphene plane spaces to produce separated graphene sheets. If the anode contains Stage-1 intercalation coke compounds, thermal shock alone can produce separated graphene sheets 16. Otherwise, thermal shock leads to the formation of exfoliated coke 14 (also referred to as coke worms), which is then subjected a mechanical shearing treatment or ultrasonication to produce the desired isolated graphene sheets 16. If the intercalation compounds contain mainly alkali metal ions (Li, Na, and/or K) residing in inter-graphene plane spaces, the resulting alkali metal-intercalated compounds may be immersed in water or water-alcohol solution (with or without sonication) to effect exfoliation and separation of graphene sheets, which are naturally dispersed in a liquid medium to form a graphene suspension. The suspension can then be shaped into a supercapacitor electrode using step (c) to be described later.

The exfoliation step can comprise heating the intercalated compound to a temperature in the range of 300-1,200° C. for a duration of 10 seconds to 2 minutes, most preferably at a temperature in the range of 600-1,000° C. for a duration of 30-60 seconds. The exfoliation step in the instant invention does not involve the evolution of undesirable species, such as NOₓ and SOₓ, which are common by-products of exfoliating conventional sulfuric or nitric acid-intercalated graphite compounds.

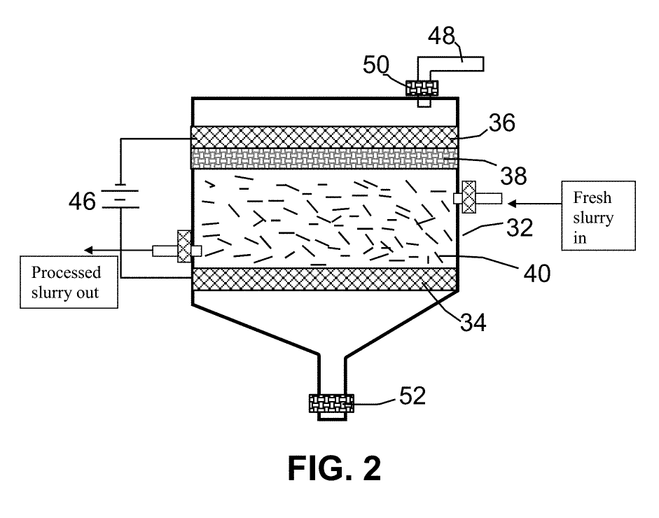

Schematically shown in FIG. 2 is an apparatus (as an example) that can be used for electrochemical intercalation of coke or coal according to a preferred embodiment of the present invention. The apparatus comprises a container 32 to accommodate electrodes and electrolyte. The anode is comprised of multiple coke or coal powder particles 40 that are dispersed in a liquid solution electrolyte (e.g., sodium (ethylenediamine) mixed with NaCl-water solution) and are supported by a porous anode supporting element 34, preferably a porous metal plate, such as nickel, titanium, or stainless steel. The powder particles 40 preferably form a continuous network of electron-conducting pathways with respect to the anode support plate 34, but are accessible to the intercalate in the liquid electrolyte solution. In some preferred embodiments, such a network of electron-conducting pathways may be achieved by dispersing and packing >20% by wt. of coke or coal powder (preferably >30% by wt. and more preferably >40% by wt.), plus some optional conductive fillers, in the electrolyte. An electrically insulating, porous separator plate 38 (e.g., Teflon fabric or glass fiber mat) is placed between the anode and the cathode 36 to prevent internal short-circuiting. A DC current source 46 is used to provide a current to the anode support element 34 and the cathode 36. The imposing current used in the electrochemical reaction preferably provides a current density in the range of 1.0 to 600 A/m², more preferably in the range of 10 to 400 A/m². Fresh electrolyte (intercalate) may be supplied from an electrolyte source (not shown) through a pipe 48 and a control valve 50. Excess electrolyte may be drained through a valve 52. In some embodiments, the electrolyte can contain the coal or coke powder dispersed therein and an additional amount of this coke/coal powder-containing electrolyte (appearing like a slurry) may be continuously or intermittently introduced into the intercalation chamber. This will make a continuous process.

Thus, in some embodiments, the invention provides a method of producing isolated graphene sheets having an average thickness smaller than 10 nm (mostly less than 2 nm) directly from a graphite mineral material having hexagonal carbon atomic interlayers with an interlayer spacing, the method comprising:
(a) forming an intercalated coke/coal compound by an electrochemical intercalation procedure which is conducted in an intercalation reactor, wherein the reactor contains (i) a liquid solution electrolyte comprising an intercalating agent and a graphene plane-wetting agent (briefly “wetting agent”) dissolved therein; (ii) a working electrode (e.g. anode) that contains the coke/coal powder as an active material in ionic contact with the liquid solution electrolyte; and (iii) a counter electrode (e.g. cathode) in ionic contact with the liquid solution electrolyte, and wherein a current is imposed upon the working electrode and the counter electrode at a current density for a duration of time sufficient for effecting electrochemical intercalation of the intercalating agent and/or the wetting agent into the interlayer spacing, wherein the wetting agent is selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid (PCA), 1-pyrenebutyric acid (PBA), 1-pyrenamine (PA), poly(sodium-4-styrene sulfonate), or a combination thereof; and
(b) exfoliating and separating the hexagonal carbon atomic interlayers from the intercalated coal/coke compound using an ultrasonication, thermal shock exposure, mechanical shearing treatment, or a combination thereof to produce the isolated graphene sheets. These graphene sheets can be dispersed in a liquid medium to form a suspension.
   Preferably, the concentration of the coke/coal powder in the liquid solution electrolyte is sufficiently high to achieve a network of electron-conducting pathways, which are in electronic contact with an anode (e.g. via an anode current collector), but not with a cathode. Step (b) is followed by a step (c) that shapes the suspension into a supercapacitor.

In an alternative electrochemical intercalation configuration, all the coke/coal powder materials to be intercalated and then exfoliated may be formed into a rod or plate that serves as an anode electrode. A metal or graphite rod or plate serves as a cathode. Both the anode and the cathode are in contact with or dispersed in a liquid solution electrolyte containing an intercalating agent and a wetting agent dissolved therein. In this alternative configuration, no coke/coal material to be intercalated is dispersed in the liquid electrolyte. A current is then imposed to the anode and the cathode to allow for electrochemical intercalation of the intercalating agent and/or the graphene plane wetting agent into the anode active material (the coke/coal material). Under favorable conditions (e.g. sufficiently high current density), exfoliation of coke/coal powder directly into graphene sheets occur. Alternatively and preferably, the electrochemical intercalation conditions are meticulously controlled to accomplish intercalation (for forming the intercalated compound) without exfoliation. The intercalated compound is then exfoliated by using the procedures described in step (b). Such a two-step procedure is preferred over the direct exfoliation procedure because the latter often occurs in an uncontrollable manner and the electrode (e.g. anode) can be broken or disrupted before intercalation into the entire rod can be completed.

The mechanical shearing treatment, used to further separate graphite flakes and possibly reduce the flake size, preferably comprises using air milling (including air jet milling), ball milling, mechanical shearing (including rotating blade fluid grinding), any fluid energy based size-reduction process, ultrasonication, or a combination thereof. The mechanical shearing (including rotating blade fluid grinding), any fluid energy based size-reduction process, and ultrasonication are preferred since these procedures involve the use of a liquid medium and the graphene sheets are naturally dispersed in the liquid medium to form a graphene suspension that can be made into a supercapacitor electrode in step (c) of the instant method to be described later.

The intercalating agent may contain a Brønsted acid selected from phosphoric acid (H₃PO₄), dichloroacetic (Cl₂CHCOOH), or an alkylsulfonic acid selected from methanesulfonic (MeSO₃H), ethanesulfonic (EtSO₃H), or 1-propanesulfonic (n-PrSO₃H), or a combination thereof.

In certain embodiments, the intercalating agent includes a metal halide. More specifically, the intercalating agent includes a metal halide selected from the group consisting of MCl (M=Li, Na, K, Cs), MCl₂ (M=Zn, Ni, Cu, Mn), MCl₃ (M=Al, Fe, Ga), MCl₄ (M=Zr, Pt), MF₂=Zn, Ni, Cu, Mn), MF₃ (M=Al, Fe, Ga), ME, (M=Zr, Pt), and combinations thereof.

Alternatively and preferably, the intercalating agent can include an alkali metal salt and this salt can be dispersed in an organic solvent or an ionic liquid. Preferably, the alkali metal salt is selected from lithium perchlorate (liClO₄), sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a sodium ionic liquid salt, lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

Preferably, the organic solvent used to dissolve the alkali metal salt is selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, propylene carbonate, ethylene carbonate (EC), dimethyl carbonate (DMC), methylethyl carbonate (MEC), diethyl carbonate (DEC), ethyl propionate, methyl propionate, gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofloroether, or a combination thereof. Essentially all of these solvents can be used in the present electrochemical intercalation method to facilitate intercalation of alkali metal ions (e.g. Li⁺, Na⁺, or K⁺) into inter-graphene plane spaces. Under favorable electrochemical conditions, most of these organic solvents are capable of intercalating into these inter-planar spaces.

The wetting agent may be selected from melamine, ammonium sulfate, sodium dodecyl sulfate, sodium (ethylenediamine), tetraalkyammonium, ammonia, carbamide, hexamethylenetetramine, organic amine, poly(sodium-4-styrene sulfonate), or a combination thereof. We have surprisingly observed several advantages that can be achieved by adding a wetting agent in the electrolyte, in addition to an intercalating agent. Typically, the addition of a wetting agent to the liquid solution electrolyte leads to thinner graphene sheets as compared to the electrochemical intercalation electrolyte containing no wetting agent. This is reflected by the typically larger specific surface areas of the mass of graphene sheets produced after exfoliation as measured by the well-known BET method. It seems that the wetting agent can readily spread into inter-layer spaces, stick to a graphene plane, and prevent graphene sheets, once formed, from being re-stacked together. This is a particularly desirable feature considering the fact that graphene planes, when separated, have a great tendency to re-stack again. The presence of these graphene plane wetting agents serves to prevent re-stacking of graphene sheets.

Some of the wetting agents (e.g. those containing an amine group) also serve to chemically functionalize the isolated graphene sheets, thereby improving the chemical or mechanical compatibility of the graphene sheets with a matrix resin (e.g. epoxy) in a composite material.

It is quite surprising that sodium ions and potassium ions, albeit significantly larger than lithium ions in terms of ionic radii, can be intercalated into inter-graphene spaces of all kinds of coke/coal materials using the instant electrochemical configurations and method. Further unexpectedly, mixed ions (e.g. Li⁺+Na⁺, or Li⁺+K⁺) intercalated into inter-graphene plane spacing of a coke/coal material are more effective than single-ion species (e.g. Li⁺ only) in exfoliating graphite to form thinner graphene sheets.

We have found that the invented electrochemical intercalation (with certain alkali metal salts and certain solvents and/or wetting agent) and thermal exfoliation can led to the formation of graphene sheets with an average thickness smaller than 5 nm. However, stage-2 and stage-3 coke intercalation compounds can lead to graphene platelets thicker than 5 nm. In order to further reduce the platelet thickness, we have conducted further studies and found that repeated electrochemical intercalations/exfoliations are an effective method of producing ultra-thin graphene sheets with an average thickness smaller than 2 nm or 5 graphene planes in each sheet or platelet and, in many cases, mostly single-layer graphene.

It may be noted that, in a coke intercalation compound (CIC) obtained by intercalation of a coke material (e.g. needle coke), the intercalant species may form a complete or partial layer in an inter-layer space or gallery. If there always exists one graphene layer between two neighboring intercalant layers, the resulting coke is referred to as a Stage-1 CIC (i.e. on average, there is one intercalation layer per one graphene plane). If n graphene layers exist between two intercalant layers, we have a Stage-n CIC. Alkali metal-intercalated coke compounds were found to be stage-2, stage-3, stage-4, or stage-5, depending on the type of intercalating agents used. It is generally believed that a necessary condition for the formation of all single-layer graphene from graphite (not coal or coke) is to have a perfect Stage-1 GIC (graphite intercalation compound) for exfoliation. Even with a Stage-1 GIC, not all of the graphene layers get exfoliated for reasons that remain unclear. Similarly, exfoliation of a Stage-n GIC (with n>5) tends to lead to a wide distribution of graphene sheet thicknesses (mostly much greater than n layers). In other words, exfoliation of Stage-5 GICs often yields graphene sheets much thicker than 10 or 20 layers. Hence, a major challenge is to be able to consistently produce graphene sheets with well-controlled dimensions (preferably ultra-thin) from acid-intercalated graphite. In this context, it was surprising for us to discover that the instant method can consistently lead to the formation of few-layer graphene and/or single-layer graphene using electrochemical methods and without using undesirable chemicals such as concentrated sulfuric acid. The production yield is typically higher than 70%, more typically higher than 80%, and most typically higher than 90%.

In step (c) of instant method, the suspension is subsequently subjected to shaping and drying treatments to form a supercapacitor. Some examples of such shaping and drying treatments are discussed in what follows:

In one example, the shaping and drying procedure includes forming the suspension into a sheet, filament, rod, or tube form using any well-known shaping process (e.g. paper-making, mat forming, extrusion, nonwoven forming, etc.). During and after this process the liquid medium is removed to form a dried shape, allowing the isolated graphene sheets to be naturally packed together to form a porous shape (e.g. a sheet of graphene paper, mat, etc.).

In some preferred embodiments, a desired amount of a foaming agent is added into the graphene suspension and step (c) of the invented process includes depositing the graphene suspension onto a surface of a solid substrate (e.g. an Al foil current collector) to form a wet graphene film under the influence of a shear stress or compressive stress to align the graphene sheets parallel to the substrate surface. The wet film is dried and heated to form a porous dry graphene film. The wet graphene film or dry graphene film is then subjected to a heat treatment at a temperature from 100° C. to 3,200° C. to activate the foaming agent and to reduce or further graphitize the graphene sheets. The porous sheet can be produced in a roll-to-roll manner. The sheet can be cut into a supercapacitor electrode of desired shape and dimensions. Desirably, the step of shaping and drying said graphene suspension comprises dispensing the suspension onto a surface or two surfaces of a current collector to form said electrode in a film form having a thickness from 1 μm to 1,000 μm. (there is no theoretical upper limit to the electrode thickness that can be produced).

Shaping of the graphene suspension (with or without a foaming agent) may be conducted using a procedure of casting, coating, spraying, printing, extrusion, fiber spinning, or a combination thereof. The step can comprise dispensing and heat treating the suspension to form a layer of graphene foam having a thickness from 1 μm to 1,000 μm. A blowing agent or foaming agent may be used. Alternatively, the step of shaping and drying the graphene suspension comprises freeze-drying the suspension to form a graphene foam electrode.

In the field of plastic processing, chemical blowing agents are mixed into the plastic pellets in the form of powder or pellets and dissolved at higher temperatures. Above a certain temperature specific for blowing agent dissolution, a gaseous reaction product (usually nitrogen or CO₂) is generated, which acts as a blowing agent. However, a chemical blowing agent cannot be dissolved in a graphene material, which is a solid, not liquid. This presents a challenge to make use of a chemical blowing agent to generate pores or cells in a graphene material.

After extensive experimenting, we have discovered that practically any chemical blowing agent (e.g. in a powder or pellet form) can be used to create pores or bubbles in a dried layer of graphene when the first heat treatment temperature is sufficient to activate the blowing reaction. The chemical blowing agent (powder or pellets) may be dispersed in the liquid medium to become a second dispersed phase (sheets of graphene material being the first dispersed phase) in the suspension, which can be deposited onto the solid supporting substrate to form a wet layer. This wet layer of graphene material may then be dried and heat treated to activate the chemical blowing agent. After a chemical blowing agent is activated and bubbles are generated, the resulting foamed graphene structure is largely maintained even when subsequently a higher heat treatment temperature is applied to the structure. This is quite unexpected, indeed.

Chemical foaming agents (CFAs) can be organic or inorganic compounds that release gasses upon thermal decomposition. CFAs are typically used to obtain medium- to high-density foams, and are often used in conjunction with physical blowing agents to obtain low-density foams. CFAs can be categorized as either endothermic or exothermic, which refers to the type of decomposition they undergo. Endothermic types absorb energy and typically release carbon dioxide and moisture upon decomposition, while the exothermic types release energy and usually generate nitrogen when decomposed. The overall gas yield and pressure of gas released by exothermic foaming agents is often higher than that of endothermic types. Endothermic CFAs are generally known to decompose in the range of 130 to 230° C. (266-446° F.), while some of the more common exothermic foaming agents decompose around 200° C. (392° F.). However, the decomposition range of most exothermic CFAs can be reduced by addition of certain compounds. The activation (decomposition) temperatures of CFAs fall into the range of our heat treatment temperatures. Examples of suitable chemical blowing agents include sodium bi-carbonate (baking soda), hydrazine, hydrazide, azodicarbonamide (exothermic chemical blowing agents), nitroso compounds (e.g. N, N-Dinitroso pentamethylene tetramine), hydrazine derivatives (e.g. 4. 4′-Oxybis (benzenesulfonyl hydrazide) and Hydrazo dicarbonamide), and hydrogen carbonate (e.g. Sodium hydrogen carbonate). These are all commercially available in plastics industry.

In the production of foamed plastics, physical blowing agents are metered into the plastic melt during foam extrusion or injection molded foaming, or supplied to one of the precursor materials during polyurethane foaming. It has not been previously known that a physical blowing agent can be used to create pores in a graphene material, which is in a solid state (not melt). We have surprisingly observed that a physical blowing agent (e.g. CO₂ or N₂) can be injected into the stream of graphene suspension prior to being coated or cast onto the supporting substrate. This would result in a foamed structure even when the liquid medium (e.g. water and/or alcohol) is removed. The dried layer of graphene material is capable of maintaining a controlled amount of pores or bubbles during liquid removal and subsequent heat treatments.

Technically feasible blowing agents include Carbon dioxide (CO₂), Nitrogen (N₂), Isobutane (C₄H₁₀), Cyclopentane (C₅H₁₀), Isopentane (C₅H₁₂), CFC-11 (CFCI₃), HCFC-22 (CHF₂CI), HCFC-142b (CF₂CICH₃), and HCFC-134a (CH₂FCF₃). However, in selecting a blowing agent, environmental safety is a major factor to consider. The Montreal Protocol and its influence on consequential agreements pose a great challenge for the producers of foam. Despite the effective properties and easy handling of the formerly applied chlorofluorocarbons, there was a worldwide agreement to ban these because of their ozone depletion potential (ODP). Partially halogenated chlorofluorocarbons are also not environmentally safe and therefore already forbidden in many countries. The alternatives are hydrocarbons, such as isobutane and pentane, and the gases such as CO₂ and nitrogen.

Except for those regulated substances, all the blowing agents recited above have been tested in our experiments. For both physical blowing agents and chemical blowing agents, the blowing agent amount introduced into the suspension is defined as a blowing agent-to-graphene material weight ratio, which is typically from 0/1.0 to 1.0/1.0.

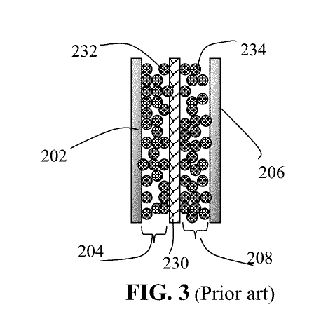

As schematically illustrated in FIG. 3, a prior art supercapacitor cell is typically composed of an anode current collector 202 (e.g. Al foil 12-15 μm thick), an anode active material layer 204 (containing an anode active material, such as activated carbon particles 232 and conductive additives that are bonded by a resin binder, such as PVDF), a porous separator 230, a cathode active material layer 208 (containing a cathode active material, such as activated carbon particles 234, and conductive additives that are all bonded by a resin binder, not shown), a cathode current collector 206 (e.g. Al foil), and a liquid electrolyte disposed in both the anode active material layer 204 (also simply referred to as the “anode layer”) and the cathode active material layer 208 (or simply “cathode layer”). The entire cell is encased in a protective housing, such as a thin plastic-aluminum foil laminate-based envelop. The prior art supercapacitor cell is typically made by a process that includes the following steps:
a) The first step is mixing particles of the anode active material (e.g. activated carbon), a conductive filler (e.g. graphite flakes), a resin binder (e.g. PVDF) in a solvent (e.g. NMP) to form an anode slurry. On a separate basis, particles of the cathode active material (e.g. activated carbon), a conductive filler (e.g. acetylene black), a resin binder (e.g. PVDF) are mixed and dispersed in a solvent (e.g. NMP) to form a cathode slurry.
b) The second step includes coating the anode slurry onto one or both primary surfaces of an anode current collector (e.g. Cu or Al foil), drying the coated layer by vaporizing the solvent (e.g. NMP) to form a dried anode electrode coated on Cu or Al foil. Similarly, the cathode slurry is coated and dried to form a dried cathode electrode coated on Al foil.
c) The third step includes laminating an anode/Al foil sheet, a porous separator layer, and a cathode/Al foil sheet together to form a 3-layer or 5-layer assembly, which is cut and slit into desired sizes and stacked to form a rectangular structure (as an example of shape) or rolled into a cylindrical cell structure.
d) The rectangular or cylindrical laminated structure is then encased in a laminated aluminum-plastic envelope or steel casing.
e) A liquid electrolyte is then injected into the laminated housing structure to make a supercapacitor cell.

There are several serious problems associated with this conventional process and the resulting supercapacitor cell:
1) It is very difficult to produce a supercapacitor electrode layer (anode layer or cathode layer) that is thicker than 100 μm and practically impossible or impractical to produce an electrode layer thicker than 200 μm. There are several reasons why this is the case. An electrode of 100 μm thickness typically requires a heating zone of 30-50 meters long in a slurry coating facility, which is too time consuming, too energy intensive, and not cost-effective. A heating zone longer than 100 meters is not unusual.
2) For some electrode active materials, such as graphene sheets, it has not been possible to produce an electrode thicker than 50 μm in a real manufacturing environment on a continuous basis. This is despite the notion that some thicker electrodes have been claimed in open or patent literature. These electrodes were prepared in a laboratory on a small scale. In a laboratory setting, presumably one could repeatedly add new materials to a layer and manually consolidate the layer to increase the thickness of an electrode. However, even with such a procedure, the resulting electrode becomes very fragile and brittle. This is even worse for graphene-based electrodes, since repeated compressions lead to re-stacking of graphene sheets and, hence, significantly reduced specific surface area and reduced specific capacitance.
3) With a conventional process, as depicted in FIG. 3, the actual mass loadings of the electrodes and the apparent densities for the active materials are too low. In most cases, the active material mass loadings of the electrodes (areal density) is significantly lower than 10 mg/cm² and the apparent volume density or tap density of the active material is typically less than 0.75 g/cm³ (more typically less than 0.5 g/cm³ and most typically less than 0.3 g/cm³) even for relatively large particles of activated carbon. In addition, there are so many other non-active materials (e.g. conductive additive and resin binder) that add additional weights and volumes to the electrode without contributing to the cell capacity. These low areal densities and low volume densities result in relatively low volumetric capacitances and low volumetric energy density.
4) The conventional process requires dispersing electrode active materials (anode active material and cathode active material) in a liquid solvent (e.g. NMP) to make a wet slurry and, upon coating on a current collector surface, the liquid solvent has to be removed to dry the electrode layer. Once the anode and cathode layers, along with a separator layer, are laminated together and packaged in a housing to make a supercapacitor cell, one then injects a liquid electrolyte into the cell. In actuality, one makes the two electrodes wet, then makes the electrodes dry, and finally makes them wet again. Such a wet-dry-wet process is clearly not a good process at all.
5) Current supercapacitors (e.g. symmetric supercapacitors or electric double layer capacitors, EDLC) still suffer from a relatively low gravimetric energy density and low volumetric energy density. Commercially available EDLCs exhibit a gravimetric energy density of approximately 6 Wh/kg and no experimental EDLC cells have been reported to exhibit an energy density higher than 10 Wh/kg (based on the total cell weight) at room temperature. Although experimental supercapacitors can exhibit large volumetric electrode capacitances (50 to 100 F/cm³ in most cases) at the electrode level, their typical active mass loading of <1 mg/cm², tap density of <0.1 g/cm³ and electrode thicknesses of up to tens of micrometers in these experimental cells remain significantly lower than those used in most commercially available electrochemical capacitors, resulting in energy storage devices with relatively low areal and volumetric capacities and low volumetric energy densities based on the cell (device) weight.
   In literature, the energy density data reported based on either the active material weight alone or electrode weight cannot directly translate into the energy densities of a practical supercapacitor cell or device. The “overhead weight” or weights of other device components (binder, conductive additive, current collectors, separator, electrolyte, and packaging) must also be taken into account. The convention production process results in an active material proportion being less than 30% by weight of the total cell weight (<15% in some cases; e.g. for graphene-based active material).

In the invented method, preferably the intercalating agent includes an alkali metal salt selected from the aforementioned list and the liquid medium contains a solvent having the alkali metal salt dissolved in the solvent to form a liquid electrolyte. This liquid electrolyte can become the electrolyte of the subsequently made supercapacitor (e.g. a lithium ion capacitor or sodium ion capacitor). In these situations, step (c) can include subjecting the graphene suspension to a forced assembly procedure, forcing the graphene sheets to assemble into an electrolyte-impregnated laminar graphene structure, wherein the multiple graphene sheets are alternately spaced by thin electrolyte layers, having a thickness from 0.4 nm to 10 nm, and the multiple graphene sheets are substantially aligned along a desired direction, and wherein the laminar graphene structure has a physical density from 0.5 to 1.7 g/cm³ and a specific surface area from 50 to 3,300 m²/g, when measured in a dried state of the laminar structure with the electrolyte removed.

A surprising advantage of this method is the notion that substantially the same electrolyte used in the electrochemical intercalation of coal/coke powder for the production of graphene sheets form the graphene suspension that is used in the subsequent forced assembly procedure. The same electrolyte becomes the electrolyte of the resulting supercapacitor.

The present invention enables a process for producing a supercapacitor cell having a high electrode thickness (no theoretical limitation on the electrode thickness that can be made by using the present process), high active material mass loading, low overhead weight and volume, high volumetric capacitance, and high volumetric energy density. The electrode produced has been pre-impregnated with an electrolyte (aqueous, organic, ionic liquid, or polymer gel), wherein all graphene surfaces have been wetted with a thin layer of electrolyte and all graphene sheets have been well-aligned along one direction and closely packed together. The graphene sheets are alternatingly spaced with ultra-thin layers of electrolyte (0.4 nm to <10 nm, more typically <5 nm, most typically <2 nm). The process obviates the need to go through the lengthy and environmentally unfriendly wet-dry-wet procedures of the prior art process.

The present invention provides a method of producing an electrolyte-impregnated laminar graphene structure for use as a supercapacitor electrode. In a preferred embodiment, the method comprises: (a) preparing a graphene dispersion having multiple isolated graphene sheets dispersed in a liquid or gel electrolyte; and (b) subjecting the graphene dispersion to a forced assembly procedure, forcing the multiple graphene sheets to assemble into the electrolyte-impregnated laminar graphene structure, wherein the multiple graphene sheets are alternately spaced by thin electrolyte layers, less than 10 nm (preferably <5 nm) in thickness, and the multiple graphene sheets are substantially aligned along a desired direction, and wherein the laminar graphene structure has a physical density from 0.5 to 1.7 g/cm³ (more typically 0.7-1.3 g/cm³) and a specific surface area from 50 to 3,300 m²/g, when measured in a dried state of the laminar structure with the electrolyte removed.

In some desired embodiments, the forced assembly procedure includes introducing a graphene dispersion (isolated graphene sheets well-dispersed in a liquid or gel electrolyte), having an initial volume V₁, in a mold cavity cell and driving a piston into the mold cavity cell to reduce the graphene dispersion volume to a smaller value V₂, allowing excess electrolyte to flow out of the cavity cell (e.g. through holes of the mold cavity cell or of the piston) and aligning the multiple graphene sheets along a direction at an angle from 0° to 90° relative to a movement direction of said piston. It may be noted that the electrolyte used in this dispersion is the electrolyte for the intended supercapacitor.

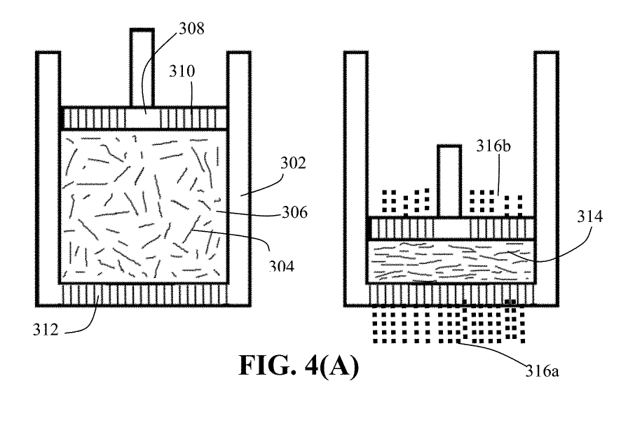

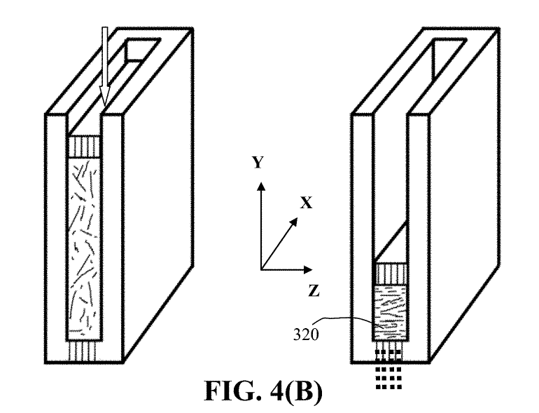

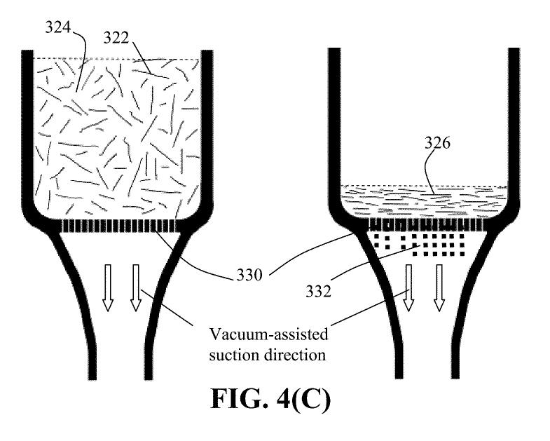

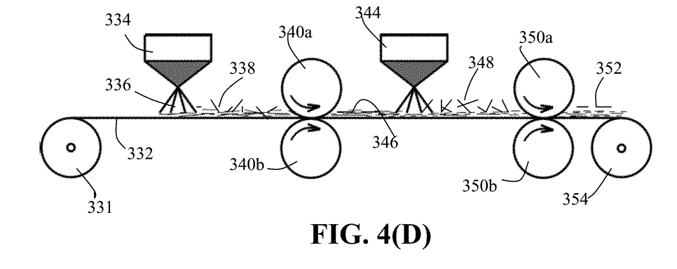

FIG. 4(A) provides a schematic drawing to illustrate an example of a compressing and consolidating operation (using a mold cavity cell 302 equipped with a piston or ram 308) for forming a layer of highly compacted and oriented graphene sheets 314. Contained in the chamber (mold cavity cell 302) is a dispersion (suspension or slurry that is composed of isolated graphene sheets 304 randomly dispersed in a liquid or gel electrolyte 306). As the piston 308 is driven downward, the volume of the dispersion is decreased by forcing excess liquid electrolyte to flow through minute channels 312 on a mold wall or through small channels 310 of the piston. These small channels can be present in any or all walls of the mold cavity and the channel sizes can be designed to permit permeation of the electrolyte species, but not the solid graphene sheets (typically 0.5-10 μm in length or width). The excess electrolyte is shown as 316a and 316b on the right diagram of FIG. 4(A). As a result of this compressing and consolidating operation, graphene sheets 314 are aligned parallel to the bottom plane or perpendicular to the layer thickness direction.

In this dispersion or suspension, practically each and every isolated graphene sheet is surrounded by electrolyte species that are physically adsorbed to or chemically bonded to graphene surface. During the subsequent consolidating and aligning operation, isolated graphene sheets remain isolated or separated from one another through electrolyte. Upon removal of the excess electrolyte, graphene sheets remain spaced apart by electrolyte and this electrolyte-filled space can be as small as 0.4 nm. Contrary to the prior art teaching that the pores in activated carbon particles or between graphene sheets must be at least 2 nm in order to allow for the formation of electric double layers of charges in the electrolyte phase (but near the electrolyte-solid interface), we have discovered that the electrolyte spacer as small as 0.4 nm is capable of storing charges. Furthermore, since the electrolyte has been pre-loaded into the spaces between isolated graphene sheets, there is no electrolyte inaccessibility issue in the presently invented supercapacitor. The present invention has essentially overcome all the significant, longstanding shortcomings of using graphene as a supercapacitor electrode active material.

Shown in FIG. 4(B) is a schematic drawing to illustrate another example of a compressing and consolidating operation (using a mold cavity cell equipped with a piston or ram) for forming a layer of highly compacted and oriented graphene sheets 320. The piston is driven downward along the Y-direction. The graphene sheets are aligned on the X-Z plane and perpendicular to X-Y plane (along the Z- or thickness direction). This layer of oriented graphene sheets can be attached to a current collector (e.g. Al foil) that is basically represented by the X-Y plane. In the resulting electrode, graphene sheets are aligned perpendicular to the current collector. Such an orientation is conducive to a faster charge response and, hence, leads to a higher power density as compared to the corresponding electrode featuring graphene sheets being aligned parallel to the current collector plane.

FIG. 4(C) provides a schematic drawing to illustrate yet another example of a compressing and consolidating operation (using a mold cavity cell with a vacuum-assisted suction provision) for forming a layer of highly compacted and oriented graphene sheets 326. The process begins with dispersing isolated graphene sheets 322 and an optional conductive filler in a liquid or gel electrolyte 324 to form a dispersion. This is followed by generating a negative pressure via a vacuum system that sucks excess electrolyte 332 through channels 330. This compressing and consolidating operation acts to reduce the dispersion volume and align all the isolated graphene sheets on the bottom plane of a mold cavity cell. Compacted graphene sheets are aligned parallel to the bottom plane or perpendicular to the layer thickness direction. Preferably, the resulting layer of electrolyte-impregnated laminar graphene structure is further compressed to achieve an even high tap density.

Thus, in some desired embodiments, the forced assembly procedure includes introducing the graphene dispersion in a mold cavity cell having an initial volume V₁, and applying a suction pressure through a porous wall of the mold cavity to reduce the graphene dispersion volume to a smaller value V₂, allowing excess electrolyte to flow out of the cavity cell through the porous wall and aligning the multiple graphene sheets along a direction at an angle from approximately 0° to approximately 90° relative to a suction pressure direction; this angle depending upon the inclination of the bottom plane with respect to the suction direction.

FIG. 4(D) shows a roll-to-roll process for producing a thick layer of electrolyte-impregnated laminar graphene structure. This process begins by feeding a continuous solid substrate 332 (e.g. PET film or stainless steel sheet) from a feeder roller 331. A dispenser 334 is operated to dispense dispersion 336 of isolated graphene sheets and electrolyte onto the substrate surface to form a layer of deposited dispersion 338, which feeds through the gap between two compressing rollers, 340a and 340b, to form a layer of electrolyte-impregnated, highly oriented graphene sheets. The graphene sheets are well-aligned on the supporting substrate plane. If so desired, a second dispenser 344 is then operated to dispense another layer of dispersion 348 on the surface of the previously consolidated dispersion layer. The two-layer structure is then driven to pass through the gap between two roll-pressing rollers 350a and 350b to form a thicker layer 352 of electrolyte-impregnated laminar graphene structure, which is taken up by a winding roller 354.

Thus, in some preferred embodiments, the forced assembly procedure includes introducing a first layer of the graphene dispersion onto a surface of a supporting conveyor and driving the layer of graphene suspension supported on the conveyor through at least a pair of pressing rollers to reduce the thickness of the graphene dispersion layer and align the multiple graphene sheets along a direction parallel to the conveyor surface for forming a layer of electrolyte-impregnated laminar graphene structure.

The procedure may further include a step of introducing a second layer of the graphene dispersion onto a surface of the layer of electrolyte-impregnated laminar structure to form a two layer laminar structure, and driving the two-layer laminar structure through at least a pair of pressing rollers to reduce a thickness of the second layer of graphene dispersion and align the multiple graphene sheets along a direction parallel to the conveyor surface for forming a layer of electrolyte-impregnated laminar structure. The same procedure may be repeated by allowing the conveyor to move toward a third set of pressing rollers, depositing additional (third) layer of graphene dispersion onto the two-layer structure, and forcing the resulting 3-layer structure to go through the gap between the two rollers in the third set to form a further compacted, electrolyte-impregnated laminar graphene structure.

The above paragraphs about FIG. 4(A)-4(B) are but four of the many examples of possibly apparatus or processes that can be used to produce electrolyte-impregnated laminar graphene strictures that contain highly oriented and closely packed graphene sheets spaced by thin layers of electrolyte.

The following examples serve to provide the best modes of practice for the present invention and should not be construed as limiting the scope of the invention:

### Example 1: Production of Isolated Graphene Sheets, Graphene Suspension, and Graphene-Based Supercapacitor Electrode from Milled Needle Coke Powder

Needle coke, milled to an average length <10 μm, was used as the anode material and 1,000 mL of a liquid solution electrolyte (typically 0.5-3 M of an alkali metal salt in an organic solvent). Ethylene carbonate (EC), propylene carbonate (PC), and diethyl carbonate (DEC) were used as the solvent. The alkali metal salts used in this example include lithium perchlorate (LiClO₄), sodium perchlorate (NaClO₄), potassium perchlorate (KClO₄), and their mixtures. The graphene plane wetting agents selected include melamine, sodium (ethylenediamine), and hexamethylenetetramine.

The anode supporting element is a stainless steel plate and the cathode is a graphite foam of approximately 4 cm in diameter and 0.2 cm in thickness, impregnated with lithium or sodium. The separator, a glass fiber fabric, was used to separate the cathode plate from the milled needle coke particles and to compress these particles down against the anode supporting element to ensure that the particles are in a good electrical contact with the anode supporting element to serve as the anode. The electrodes, electrolyte, and separator are contained in a Buchner-type funnel to form an electrochemical cell. The anode supporting element, the cathode, and the separator are porous to permit intercalate (contained in the electrolyte) to saturate the coke and to pass through the cell from top to bottom.

The milled needle coke particles were subjected to an electrochemical charging treatment (i.e. charging alkali metal ions into inter-graphene plane spaces in a coke structure at a current of 0.5 amps (current density of about 0.04 amps/cm²) and at a cell voltage of about 4-6 volts for 2-5 hours. These values may be varied with changes in cell configuration and makeup. Following electrochemical charging treatment, the resulting intercalated particles (beads) were washed with water and dried.

Subsequently, some of the alkali metal ion-intercalated coke compound was transferred to a water bath. The compound, upon contact with water, was found to induce extremely rapid and high expansions of graphite crystallites. Subsequently, some portion of this expanded/exfoliated graphite solution was subjected to sonication. Various samples were collected with their morphology studied by SEM and TEM observations and their specific surface areas measured by the well-known BET method.

TABLE 1
Results of varying types of liquid electrolytes (alkali
metal salts, solvents, and wetting agents).

| | | | Specific | |
|---|---|---|---|---|
| | | | surface | |
| | | Wetting | area | |
| Sample | Intercalating agents | agent | (m²/g) | Comments |
| K-1 | LiClO₄ in EC | None | 825 | >80% single-layer |
| K-1-w | LiClO₄ in EC | Melamine | 898 | >85% single-layer |
| K-2 | NaClO₄ in EC | None | 820 | >80% single-layer |
| K-2-w | NaClO₄ in EC | Melamine | 944 | >90% single-layer |
| K-3 | KClO₄ in EC | None | 635 | >45% single-layer |
| K-3-w | KClO₄ in EC | Melamine | 720 | >65% single-layer |
| K-4 | (LiClO₄ + | None | 912 | >90% single-layer |
| | NaClO₄) in EC | | | |
| K-4-w | (LiClO₄ + | Sodium | 995 | >95% single-layer |
| | NaClO₄) in EC | (ethylene- | | |
| | | diamine) | | |
| K-5 | (LiClO₄ + | None | 735 | >70% single-layer |
| | KClO₄) in EC | | | |
| K-5-w | (LiClO₄ + | Sodium | 845 | >80% single-layer |
| | KClO₄) in EC | (ethylene- | | |
| | | diamine) | | |
| K-6 | NaClO₄ + PC | None | 695 | >60% single-layer |
| K-6-w | NaClO₄ + PC | Hexa- | 855 | >85% single-layer |
| | | methylene | | |
| | | tetramine | | |
| K-7 | LiClO₄ + PC | None | 660 | >50% single-layer |
| K-7-w | LiClO₄ + PC | Hexa- | 788 | >75% single-layer |
| | | methylene | | |
| | | tetramine | | |

Several important observations may be made from the data in this table:
1) The intercalating electrolyte containing a graphene plane wetting agent leads to thinner (mostly single-layer) graphene sheets as compared to the electrolyte containing no such wetting agent.
2) Larger alkali metal ions (Na⁺ and K⁺), relative to Li⁺, are also effective intercalants in the production of ultra-thin graphene sheets. Actually, Na⁺ ions are unexpectedly more effective than Li⁺ in this aspect.
3) A mixture of two alkali metal salts (e.g. LiClO₄+NaClO₄) is more effective than single components alone in producing single-layer graphene sheets.
4) EC appears to be more effective than PC.
5) Products containing a majority of graphene sheets being single-layer graphene can be readily produced using the presently invented electrochemical intercalation method.

Certain amounts of the mostly multi-layer graphene sheets were then subjected to re-intercalation under comparable electrochemical intercalation conditions to obtain re-intercalated NGPs. Subsequently, these re-intercalated NGPs were transferred to an ultrasonication bath to produce ultra-thin graphene sheets. Electron microscopic examinations of selected samples indicate that the majority of the resulting NGPs are single-layer graphene sheets.

Suspensions containing mostly single-layer graphene dispersed in the alkali metal salt-organic solvent liquid (originally used in the electrochemical reactor) were then made into supercapacitors according to the procedures described in FIG. 4(A)-(D). The specific capacitance, energy density, power density, and cycling behaviors of resulting supercapacitors were then investigated. The testing procedures are described in Example 6.

### Comparative Example 1: Concentrated Sulfuric-Nitric Acid-Intercalated Needle Coke Particles

One gram of milled needle coke powder as used in Example 1 were intercalated with a mixture of sulfuric acid, nitric acid, and potassium permanganate at a weight ratio of 4:1:0.05 (graphite-to-intercalate ratio of 1:3) for four hours. Upon completion of the intercalation reaction, the mixture was poured into deionized water and filtered. The sample was then washed with 5% HCl solution to remove most of the sulfate ions and residual salt and then repeatedly rinsed with deionized water until the pH of the filtrate was approximately 5. The dried sample was then exfoliated at 1,000° C. for 45 seconds. The resulting NGPs were examined using SEM and TEM and their length (largest lateral dimension) and thickness were measured. It was observed that, in comparison with the conventional strong acid process for producing graphene, the presently invented electrochemical intercalation method leads to graphene sheets of comparable thickness distribution, but much larger lateral dimensions (3-5 μm vs. 200-300 nm). Graphene sheets were made into graphene paper layer using a well-known vacuum-assisted filtration procedure. The graphene paper prepared from hydrazine-reduced graphene oxide (made from sulfuric-nitric acid-intercalated coke) exhibits electrical conductivity values of 11-143 S/cm. The graphene paper prepared from the relatively oxidation-free graphene sheets made by the presently invented electrochemical intercalation exhibit conductivity values of 1,500-3,600 S/cm.

### Example 2: Graphene Sheets and Supercapacitor Electrodes from Milled Lignite Coal Powder

In one example, samples of two grams each of lignite coal were milled down to an average diameter of 25.6 μm. The powder samples were subjected to similar electrochemical intercalation conditions described in Example 1, but with different alkali metal salts and solvents. The lignite coal powder samples were subjected to an electrochemical intercalation treatment at a current of 0.5 amps (current density of about 0.04 amps/cm²) and at a cell voltage of about 5 volts for 3 hours. Following the electrochemical intercalation treatment, the resulting intercalated powder was removed from the electrochemical reactor and dried.

Subsequently, the coal intercalation compound was transferred to a furnace pre-set at a temperature of 950° C. for 45 seconds. The compound was found to induce rapid and high expansions of graphite-like crystallites with an expansion ratio of greater than 30. After a mechanical shearing treatment in a high-shear rotating blade device for 15 minutes, the resulting graphene sheets exhibit a thickness ranging from single-layer graphene sheets to 8-layer graphene sheets based on SEM and TEM observations. Results are summarized in Table 2 below:

TABLE 2
Results of varying types of intercalating agents and wetting agents.

| | | | Specific | |
|---|---|---|---|---|
| | | | surface | |
| | Alkali metal salt | Wetting | area | |
| Sample | in solvent | agent | (m²/g) | Comments |
| L-1 | LiPF₆ + PC | None | 733 | >65% single-layer |
| L-1-w | LiPF₆ + PC | Tetraalky- | 795 | >75% single-layer |
| | | ammonium | | |
| L-2 | (LiPF₆ + | None | 786 | >75% single-layer |
| | NaPF₆) + PC | | | |
| L-2-w | (LiPF₆ + | Tetraalky- | 866 | >85% single-layer |
| | NaPF₆) + PC | ammonium | | |
| L-3 | LiBF₄ + PC | None | 674 | >60% single-layer |
| L-3-w | LiBF₄ + PC | Carbamide | 755 | >70% single-layer |
| L-4 | LiTFSI + (PC + | None | 679 | >60% single-layer |
| | EC) | | | |
| L-4-w | LiTFSI + (PC + | Carbamide | 772 | >70% single-layer |
| | EC) | | | |
| L-5 | LiPF₆ + DOL | None | 633 | >50% single-layer |
| L-5-w | LiPF₆ + DOL | Organic | 726 | >65% single-layer |
| | | amine | | |
| L-6 | LiPF₆ + DME | None | 669 | >60% single-layer |
| L-6-w | LiPF₆ + DME | Organic | 779 | >75% single-layer |
| | | amine | | |

It may be noted that the interstitial spaces between two hexagonal carbon atomic planes (graphene planes) are only approximately 0.28 nm (the plane-to-plane distance is 0.34 nm). A skilled person in the art would have predicted that larger molecules and/or ions (K⁺ vs. Li⁺) cannot intercalate into interstitial spaces of a layered graphite material. After intensive R&D efforts, we found that electrochemical methods with a proper combination of an alkali metal salt and solvent, and an adequate magnitude of the imposing current density could be used to open up the interstitial spaces in graphene-like domains to accommodate much larger molecules and/or ions. The presence of a graphene plane-wetting agent serves to prevent exfoliated graphene sheets from being re-stacked back to a graphite structure.

Re-intercalation of those multi-layer graphene platelets and subsequent exfoliation resulted in further reduction in platelet thickness, with an average thickness of approximately 0.75 nm (approximately 2 graphene planes on average).

Suspensions containing mostly single-layer graphene dispersed in the alkali metal salt-organic solvent liquid (originally used in the electrochemical reactor) were then made into supercapacitors according to the procedures described in FIG. 4(A)-(D). The specific capacitance, energy density, power density, and cycling behaviors of resulting supercapacitors were then investigated.

### Example 3: Production of Graphene-Based Supercapacitor Electrodes from Electrochemical Treatments of Milled Petroleum Needle Coke in an Aqueous Electrolyte Solution

Samples of two grams each of needle coke powder were milled down to an average length of 36 μm. The powder samples were subjected to electrochemical intercalation in aqueous electrolyte. A broad array of metal halide salts were dissolved in deionized water to form a liquid electrolyte. The wetting agents investigated include ammonia, ammonium sulfate, and sodium dodecyl sulfate. The graphite ore samples were subjected to an electrochemical intercalation treatment at a current of 0.5 amps (current density of about 0.04 amps/cm²) and at a cell voltage of about 1.8 volts for 3 hours. Following the electrochemical intercalation treatment, the resulting intercalated coke (mostly Stage-1 CIC with some Stage-2) was removed from the electrochemical reactor and dried.

Subsequently, the intercalated compound was transferred to a furnace pre-set at a temperature of 1,025° C. for 60 seconds. The compound was found to induce rapid and high expansions of graphite crystallites with an expansion ratio of greater than 80. After a mechanical shearing treatment in a high-shear rotating blade device for 15 minutes, the resulting graphene sheets exhibit a thickness ranging from single-layer graphene sheets to 5-layer graphene sheets based on SEM and TEM observations. Results are summarized in Table 3 below. These data have indicated that a wide variety of metal salts (MCl, MCl₂, and MCl₃, etc.; M=a metal) dissolved in a select solvent (e.g. water) can be utilized as an intercalating agent in the presently invented method, making this a versatile and environmentally benign approach (e.g. as opposed to the conventional method using strong sulfuric acid and oxidizing agents). It is also surprising to discover that a graphene plane wetting agent can be used to significantly improve the electrochemical intercalation and exfoliation process for the production of ultra-thin graphene sheets.

TABLE 3
Results of varying types of intercalating and wetting agents.

| | | | Specific | % of single |
|---|---|---|---|---|
| | | | surface | or few-layer |
| | | Wetting | area | graphene sheets |
| Sample | Aqueous electrolyte | agent | (m²/g) | (1-10 layers) |
| N-1 | LiCl + water | None | 332 | >35% |
| N-1-w | LiCl + watr | Ammonium | 454 | >60% |
| | | sulfate | | |
| N-2 | LiI + water | None | 228 | >20% |
| N-2-w | LiI + water | Ammonium | 466 | >60% |
| | | sulfate | | |
| N-3 | NaCl + water | None | 216 | >15% |
| N-3-w | NaCl + water | Sodium | 398 | >50% |
| | | dodecyl | | |
| | | sulfate | | |
| N-4 | NaF + water | None | 225 | >20% |
| N-4-w | NaF + water | Sodium | 368 | >40% |
| | | dodecyl | | |
| | | sulfate | | |
| N-5 | NaCl + LiCl + water | None | 276 | >30% |
| N-5-w | NaCl + LiCl + water | Ammonium | 378 | >40% |
| | | sulfate | | |
| N-6 | ZnCl₂ + water | None | 204 | >15% |
| N-6-w | ZnCl₂ + water | Ammonia | 374 | >40% |
| N-7 | FeCl₃ + water | None | 334 | >35% |
| N-7-w | FeCl₃ + water | Ammonia | 465 | >60% |

A small amount of NGPs was mixed with water and ultrasonicated for 15 minutes to obtain a suspension, which was then cast onto a glass surface to produce a thin film of approximately 92 nm in thickness. Based on a four-point probe approach, the electrical conductivity of the NGP film was found to be 2,806 S/cm. When used as a supercapacitor electrode, the specific capacitance was in the range of 157-225 F/g.

### Comparative Example 3: Conventional Hummers Method

Highly intercalated and oxidized graphite was prepared by oxidation of milled needle coke particles (same as in Example 3) with sulfuric acid, nitrate, and potassium permanganate according to the method of Hummers [U.S. Pat. No. 2,798,878, Jul. 9, 1957]. Upon completion of the reaction (10 hours allowed), the mixture was poured into deionized water and filtered. The sample was then washed with 5% HCl solution to remove most of the sulfate ions and residual salt and then repeatedly rinsed with deionized water until the pH of the filtrate was approximately 5. The intent was to remove all sulfuric and nitric acid residue out of graphite interstices. The slurry was spray-dried and stored in a vacuum oven at 65° C. for 24 hours. The interlayer spacing of the resulting powder was determined by the Debey-Scherrer X-ray technique to be approximately 0.76 nm (7.6 Å), indicating that graphite has been converted into graphite oxide (Stage-1 and Stage-2 GICs). The dried, intercalated compound was placed in a quartz tube and inserted into a horizontal tube furnace pre-set at 1050° C. for 45 seconds. The exfoliated worms were mixed with water and then subjected to a mechanical shearing treatment using a high-shear dispersion machine for 20 minutes. The resulting graphene sheets were found to have a thickness of 2.2-7.9 nm. The resulting supercapacitor electrode exhibits a specific surface areas from 157 to 324 m²/g and specific capacitance of 125-176 F/g. These values are not nearly as good as what is achieved by the instant method (255-567 m²/g and 157-225 F/g, respectively), which is also more environmentally benign.

### Example 4: Production of Isolated Graphene Sheets from Anthracite Coal

Taixi coal from Shanxi, China was used as the starting material for the preparation of isolated graphene sheets. The raw coal was ground and sieved to a powder with an average particle size less than 200 The coal powder was further size-reduced for 2.5 h by ball milling, and the diameter of more than 90% of milled powder particles is less than 15 μm after milling. The raw coal powder was treated with hydrochloride in a beaker at 50° C. for 4 h to make modified coal (MC), and then it was washed with distilled water until no was detected in the filtrate. The modified coal was heat treated in the presence of Fe to transform coal into graphite-like carbon. The MC powder and Fe₂(SO₄)₃ [TX-de:Fe₂(SO₄)₃=16:12.6] was well-mixed by ball milling for 2 min, and then the mixture was subjected to catalytic graphitization at 2400° C. for 2 h under argon.

The coal-derived powder samples were subjected to electrochemical intercalation under conditions that are comparable to those used in Example 1. Subsequently, the intercalated compound was transferred to a furnace pre-set at a temperature of 1,050° C. for 60 seconds. The compound was found to induce rapid and high expansions of graphite crystallites with an expansion ratio of greater than 200. After a mechanical shearing treatment in a high-shear rotating blade device for 15 minutes, the resulting graphene sheets exhibit a thickness ranging from single-layer graphene sheets to 5-layer graphene sheets based on SEM and TEM observations.

Suspensions containing isolated graphene sheets re-dispersed in water were then cast onto a glass surface using a doctor's blade to exert shear stresses, inducing graphene sheet orientations. The resulting graphene films, after removal of liquid, have a thickness of 200 μm. The graphene films were then subjected to heat treatments that involve a thermal reduction temperature of 80-1,500° C. for 1-5 hours. This heat treatment generated a layer of graphene foam as a supercapacitor electrode.

### Example 5: Production of Graphene Electrodes from Bituminous Coal

In an example, 300 mg of bituminous coal was used as the anode material and 1,000 mL and 1 M of an alkali metal salt in an organic solvent as a liquid solution electrolyte. Ethylene carbonate (EC) and propylene carbonate (PC), separately, were used as the solvent. The alkali metal salts used in this example include lithium perchlorate (LiClO₄) and sodium perchlorate (NaClO₄).

The anode supporting element is a stainless steel plate and the cathode is a graphite foam of approximately 4 cm in diameter and 0.2 cm in thickness, impregnated with lithium or sodium. The separator, a glass fiber fabric, was used to separate the cathode plate from the coal particles and to compress these particles down against the anode supporting element to ensure that the particles are in a good electrical contact with the anode supporting element to serve as the anode. The electrodes, electrolyte, and separator are contained in a Buchner-type funnel to form an electrochemical cell. The anode supporting element, the cathode, and the separator are porous to permit intercalate (contained in the electrolyte) to saturate the coke and to pass through the cell from top to bottom.

The coal particles were subjected to an electrochemical charging treatment at a current of 0.5 amps (current density of about 0.04 amps/cm²) and at a cell voltage of about 4-5 volts for 2 hours. These values may be varied with changes in cell configuration and makeup. Following electrochemical charging treatment, the resulting reacted particles were washed with water. The solution was cooled to room temperature and poured into a beaker containing 100 ml ice, followed by a step of adding NaOH (3M) until the pH value reached 7. The neutral mixture was subjected to cross-flow ultrafiltration for 2 hours. After purification, the solution was concentrated using rotary evaporation to obtain solid humic acid sheets.

The humic acid sheets were re-dispersed in water. The resulting suspension was cast into films and then heat-treated at 100° C. for 1 hour and then 350° C. for 4 hours to produce sheets of graphene foam. The specific capacitance of these sheets of foam was found to be 175-210 F/g.

### Example 6: Details about Evaluation of Various Supercapacitor Cells

In a conventional cell, an electrode (cathode or anode), is typically composed of 85% an electrode active material (e.g. graphene, activated carbon, inorganic nano discs, etc.), 5% Super-P (acetylene black-based conductive additive), and 10% PTFE, which were mixed and coated on Al foil. The thickness of electrode is around 100 μm. For each sample, both coin-size and pouch cells were assembled in a glove box. The capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

Galvanostatic charge/discharge tests were conducted on the samples to evaluate the electrochemical performance. For the galvanostatic tests, the specific capacity (q) is calculated as

q=I*t/m (1)

where I is the constant current in mA, t is the time in hours, and m is the cathode active material mass in grams. With voltage V, the specific energy (E) is calculated as,

E=∫Vdq (2)

The specific power (P) can be calculated as

P=(E/t)(W/kg) (3)

where t is the total charge or discharge step time in hours.
The specific capacitance (C) of the cell is represented by the slope at each point of the voltage vs. specific capacity plot,

C=dq/dV (4)

For each sample, several current density (representing charge/discharge rates) were imposed to determine the electrochemical responses, allowing for calculations of energy density and power density values required of the construction of a Ragone plot (power density vs. energy density).

### Example 7: Achievable Tap Density of the Electrode and its Effect on Electrochemical Performance of Supercapacitor Cells

The presently invented process (as described in FIG. 4(A)-(D)) allows us to prepare a graphene-based supercapacitor electrode of any practical tap density from 0.3 to 1.1 g/cm³. It may be noted that the graphene-based supercapacitor electrodes prepared by conventional processes are limited to <0.3 and mostly <0.1 g/cm³. Furthermore, as discussed earlier, only thinner electrodes can be prepared using these conventional processes. As a point of reference, the activated carbon-based electrode exhibits a tap density typically from 0.3 to 0.5 g/cm³.

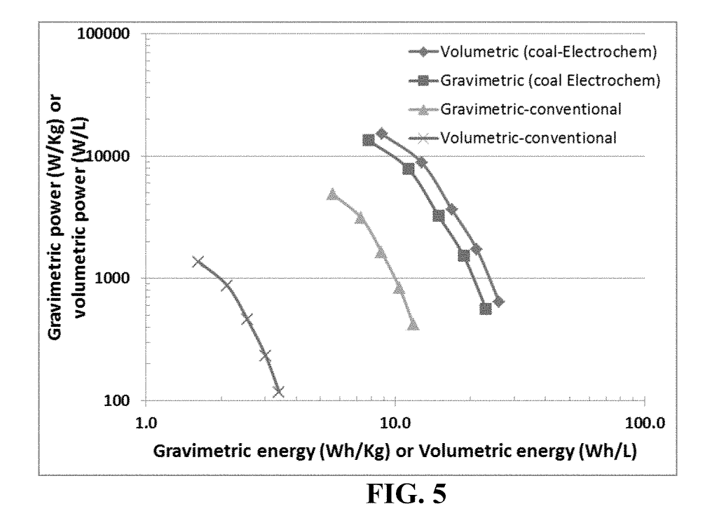

A series of EDLC electrodes with different tap densities were prepared from the same batch of graphene suspension. The volume and weights of an electrode were measured before and after foaming and before and after roll-pressing. These measurements enabled us to estimate the tap density of the dried electrode. For comparison purposes, graphene-based electrodes of comparable thickness (70-75 μm) were also prepared using the conventional slurry coating process (the wet-dry-wet procedures). The electrode specific capacitance values of these supercapacitors using an organic electrolyte (acetonitrile) are summarized in FIG. 5. There are several significant observations that can be made from these data:
(A) Given comparable electrode thickness, the presently invented graphene supercapacitors prepared from the supercritical fluid route exhibit significantly higher gravimetric specific capacitance (266-302 F/g) as compared to those (typically 130-150 F/g) of the corresponding graphene-based electrodes prepared by the conventional process, all based on EDLC alone.
(B) The highest achievable tap density of the electrode prepared by the conventional method is 0.14-0.28 g/cm³. In contrast, the presently invented process makes it possible to achieve a tap density of 0.35-1.13 g/cm³ (based on this series of samples alone); these unprecedented values even surpass those (0.3-0.5 g/cm³) of activated carbon electrodes by a large margin. This is truly remarkable and unexpected.
(C) The presently invented graphene electrodes exhibit a volumetric specific capacitance up to 301 F/cm³, which is also an unprecedented value. In contrast, the graphene electrodes prepared according to the conventional method shows a specific capacitance in the range of 21-40 F/cm³; the differences are dramatic.

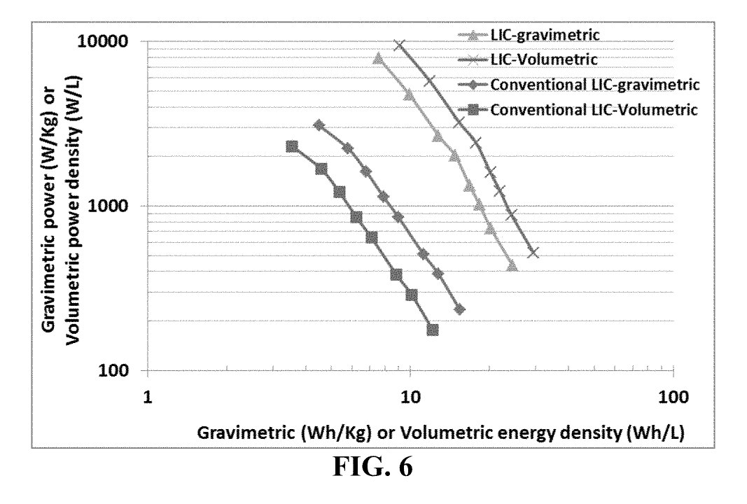

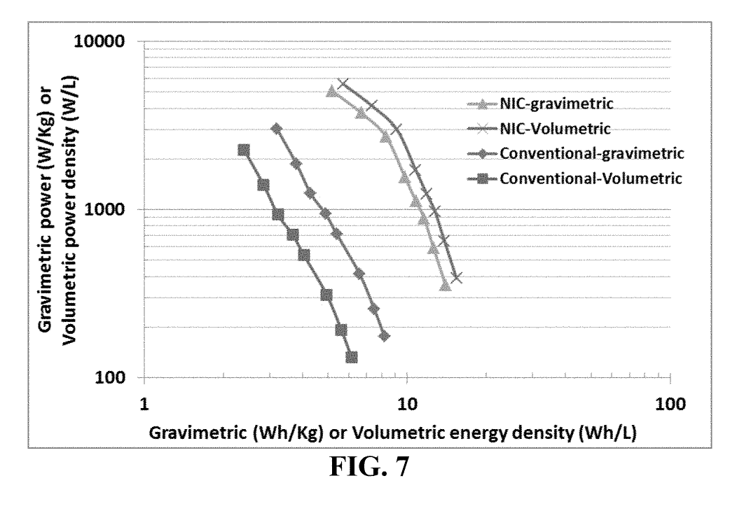

Shown in FIG. 6 are Ragone plots (gravimetric and volumetric power density vs. energy density) of two sets of lithium-ion capacitors (LIC) containing graphene sheets as the cathode electrode active material and lithiated needle coke particles as the anode active material. One of the two series of supercapacitors was based on the graphene-based cathode (coke-derived graphene) prepared according to an embodiment of instant invention and the other was by the conventional slurry coating of electrodes (natural graphite-derived graphene sheets). Shown in FIG. 7 are Ragone plots (gravimetric and volumetric power density vs. energy density) of two sets of sodium-ion capacitors (NIC) containing graphene sheets as the cathode electrode active material and sodiated needle coke particles as the anode active material. Several significant observations can be made from these data:
(A) Both the gravimetric and volumetric energy densities and power densities of the LIC cells prepared by the presently invented method are significantly higher than those of their counterparts prepared via the conventional method (denoted as “conventional”). The differences are highly dramatic and are mainly due to the high active material mass loading (>20 mg/cm²) associated with the presently invented cells, reduced proportion of overhead components (non-active) relative to the active material weight/volume, no binder resin, the ability of the inventive method to more effectively pack graphene sheets together without graphene sheet re-stacking.
(B) For the cells prepared by the conventional method, the absolute magnitudes of the volumetric energy densities and volumetric power densities are significantly lower than those of their gravimetric energy densities and gravimetric power densities, due to the very low tap density (packing density of 0.29 g/cm³) of isolated graphene sheet-based electrodes prepared by the conventional slurry coating method.
(C) In contrast, for the cells prepared by the presently invented method, the absolute magnitudes of the volumetric energy densities and volumetric power densities are higher than those of their gravimetric energy densities and gravimetric power densities, due to the relatively high tap density (packing density of 1.13 g/cm³) of graphene-based cathodes prepared by the presently invented method.

1. A method of producing a graphene-based supercapacitor electrode from a supply of coke or coal powder containing therein domains of hexagonal carbon atoms and/or hexagonal carbon atomic interlayers with an interlayer spacing, said method comprising:
(a) forming an intercalated coke or coal compound by an electrochemical intercalation procedure which is conducted in an intercalation reactor, wherein said reactor contains (i) a liquid solution electrolyte comprising an intercalating agent; (ii) a working electrode that contains said coke or coal powder as an active material in ionic contact with said liquid solution electrolyte, wherein said coke or coal powder is selected from the group consisting of petroleum coke, coal-derived coke, meso-phase coke, synthetic coke, leonardite, anthracite, lignite coal, bituminous coal, natural coal mineral powder, and a combination thereof; and (iii) a counter electrode in ionic contact with said liquid solution electrolyte, and wherein a current is imposed upon said working electrode and said counter electrode at a current density for a duration of time sufficient for effecting electrochemical intercalation of said intercalating agent into said interlayer spacing;
(b) exfoliating and separating said hexagonal carbon atomic interlayers from said intercalated coke or coal compound using an ultrasonication, thermal shock exposure, mechanical shearing treatment, or a combination thereof to produce isolated graphene sheets, which are dispersed in a liquid medium to form a graphene suspension; and
(c) shaping or shaping and drying said graphene suspension into said supercapacitor electrode that is porous and has a specific surface area greater than 200 m²/g.

2. The method of claim 1, wherein multiple particles of said coke or coal powder are dispersed in said liquid solution electrolyte, disposed in a working electrode compartment, and supported or confined by a current collector in electronic contact therewith, and wherein said working electrode compartment and said multiple particles supported thereon or confined therein are not in electronic contact with said counter electrode.

3. The method of claim 1 wherein said particles of said coke or coal powder have never been previously intercalated or oxidized prior to step (a).

4. The method of claim 1 wherein said supercapacitor electrode is in a paper sheet, porous film, porous filament, porous rod, or porous tube form.

5. The method of claim 2, wherein said multiple particles are clustered together to form a network of electron-conducting pathways.

6. The method of claim 1, wherein said reactor further contains a graphene plane-wetting agent dissolved in said liquid solution electrolyte.

7. The method of claim 6, wherein said graphene plane-wetting agent is selected from melamine, ammonium sulfate, sodium dodecyl sulfate, sodium (ethylenediamine), tetraalkyammonium, ammonia, carbamide, hexamethylenetetramine, organic amine, pyrene, 1-pyrenecarboxylic acid, 1-pyrenebutyric acid, 1-pyrenamine, poly(sodium-4-styrene sulfonate), or a combination thereof.

8. The method of claim 1, wherein said method is conducted intermittently or continuously and said supply of coke or coal powder and said liquid solution electrolyte are provided into said reactor intermittently or continuously.

9. The method of claim 1, wherein said coke or coal powder in said working electrode compartment is dispersed in the liquid solution electrolyte at a concentration higher than 20% by weight.

10. The method of claim 1, wherein said coke or coal powder in said working electrode compartment is dispersed in the liquid solution electrolyte at a concentration higher than 50% by weight.

11. The method of claim 1, wherein said mechanical shearing treatment comprises air milling, air jet milling, ball milling, rotating-blade mechanical shearing, or a combination thereof.

12. The method of claim 1, wherein the imposing current provides a current density in the range of 0.1 to 300 A/m².

13. The method of claim 1, wherein the imposing current provides a current density in the range of 10 to 600 A/m².

14. The method of claim 1, wherein said thermal shock exposure comprises heating said intercalated coke or coal compound to a temperature in the range of 300-1,200° C. for a period of 15 seconds to 2 minutes.

15. The method of claim 1, wherein said isolated graphene sheets contain single-layer graphene.

16. The method of claim 1, wherein said isolated graphene sheets contain few-layer graphene having 2-10 hexagonal carbon atomic interlayers or graphene planes.

17. The method of claim 6, wherein said electrochemical intercalation includes intercalation of both said intercalating agent and said wetting agent into the interlayer spacing.

18. The method of claim 1, further comprising a step of re-intercalating said isolated graphene sheets using an electrochemical or chemical intercalation method to obtain intercalated graphene sheets and a step of exfoliating and separating said intercalated graphene sheets to produce single-layer graphene sheets using ultrasonication, thermal shock exposure, exposure to water solution, mechanical shearing treatment, or a combination thereof.

19. The method of claim 1, wherein said intercalating agent includes a species selected from a Brønsted acid selected from phosphoric acid (H₃PO₄), dichloroacetic (Cl₂CHCOOH), or an alkylsulfonic acid selected from methanesulfonic (MeSO₃H), ethanesulfonic (EtSO₃H), or 1-propanesulfonic (n-PrSO₃H), or a combination thereof.

20. The method of claim 1, wherein said intercalating agent includes a metal halide selected from the group consisting of MCl (M=Li, Na, K, Cs), MCl₂ (M=Zn, Ni, Cu, Mn), MCl₃ (M=Al, Fe, Ga), MCl₄ (M=Zr, Pt), MF₂ (M=Zn, Ni, Cu, Mn), MF₃ (M=Al, Fe, Ga), MF₄ (M=Zr, Pt), and combinations thereof.

21. The method of claim 1, wherein said intercalating agent includes an alkali metal salt selected from lithium perchlorate (LiClO₄), sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a sodium ionic liquid salt, lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

22. The method of claim 1, wherein said intercalating agent includes an organic solvent selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), propylene carbonate (PC), dimethyl carbonate (DMC), methylethyl carbonate (MEC), diethyl carbonate (DEC), ethyl propionate, methyl propionate, gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofloroether, or a combination thereof.

23. The method of claim 21, wherein said liquid medium contains a solvent and said alkali metal salt dissolved in said solvent to form a liquid electrolyte, and said step (c) includes subjecting said graphene suspension to a forced assembly procedure, forcing said graphene sheets to assemble into an electrolyte-impregnated laminar graphene structure, wherein said multiple graphene sheets are alternately spaced by thin electrolyte layers, having a thickness from 0.4 nm to 10 nm, and said multiple graphene sheets are substantially aligned along a desired direction, and wherein said laminar graphene structure has a physical density from 0.5 to 1.7 g/cm³ and a specific surface area from 50 to 3,300 m²/g, when measured in a dried state of said laminar structure with said electrolyte removed.

24. The method of claim 22, wherein said liquid medium contains said organic solvent and an alkali metal salt dissolved in said organic solvent to form a liquid electrolyte, and said step (c) includes subjecting said graphene suspension to a forced assembly procedure, forcing said graphene sheets to assemble into an electrolyte-impregnated laminar graphene structure, wherein said multiple graphene sheets are alternately spaced by thin electrolyte layers, having a thickness from 0.4 nm to 10 nm, and said multiple graphene sheets are substantially aligned along a desired direction, and wherein said laminar graphene structure has a physical density from 0.5 to 1.7 g/cm³ and a specific surface area from 50 to 3,300 m²/g, when measured in a dried state of said laminar structure with said electrolyte removed.

25. The method of claim 24 wherein said alkali metal salt is selected from lithium perchlorate (LiClO₄), sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a sodium ionic liquid salt, lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

26. The method of claim 23, wherein said forced assembly procedure includes introducing said graphene suspension, having an initial volume V₁, in a mold cavity cell and driving a piston into said mold cavity cell to reduce the graphene dispersion volume to a smaller value V₂, allowing excess electrolyte to flow out of said cavity cell and aligning said multiple graphene sheets along a desired direction.

27. The method of claim 24, wherein said forced assembly procedure includes introducing said graphene dispersion in a mold cavity cell having an initial volume V₁, and applying a suction pressure through a porous wall of said mold cavity to reduce the graphene dispersion volume to a smaller value V₂, allowing excess electrolyte to flow out of said cavity cell through said porous wall and aligning said multiple graphene sheets along a desired direction.

28. The method of claim 23, wherein said forced assembly procedure includes introducing a first layer of said graphene dispersion onto a surface of a supporting conveyor and driving said layer of graphene suspension supported on said conveyor through at least a pair of pressing rollers to reduce a thickness of said graphene dispersion layer and align said multiple graphene sheets along a direction parallel to said conveyor surface for forming a layer of electrolyte-impregnated laminar graphene structure.

29. The method of claim 28, further including a step of introducing a second layer of said graphene dispersion onto a surface of said layer of electrolyte-impregnated laminar graphene structure to form a two layer laminar structure, and driving said two-layer laminar structure through at least a pair of pressing rollers to reduce a thickness of said second layer of graphene dispersion and align said multiple graphene sheets along a direction parallel to said conveyor surface for forming a layer of electrolyte-impregnated laminar graphene structure.

30. The method of claim 23, further including a step of compressing or roll-pressing said electrolyte-impregnated laminar structure to reduce a thin electrolyte layer thickness in said impregnated laminar structure, improve orientation of graphene sheets, and squeeze excess electrolyte out of said impregnated laminar graphene structure for forming said supercapacitor electrode.

31. The method of claim 23, which includes a roll-to-roll process wherein said forced assembly procedure includes feeding said supporting conveyor, in a continuous film form, from a feeder roller to a deposition zone, continuously or intermittently depositing said graphene dispersion onto a surface of said supporting conveyor film to form said layer of graphene dispersion thereon, and collecting said layer of electrolyte-impregnated laminar graphene structure supported on conveyor film on a collector roller.

32. The method of claim 1, wherein said step of shaping and drying said graphene suspension comprises dispensing said suspension onto a surface or two surfaces of a current collector to form said electrode in a film form having a thickness from 1 μm to 1,000 μm.

33. The method of claim 1, wherein said step of shaping and drying said graphene suspension comprises dispensing and heat treating said suspension to form a layer of graphene foam having a thickness from 1 μm to 1,000 μm.

34. The method of claim 1, wherein said suspension contains a foaming agent or blowing agent and said step of shaping and drying said graphene suspension comprises dispensing and heat treating said suspension to activate said foaming or blowing agent for forming a layer of graphene foam.

35. The method of claim 1, wherein said step of shaping and drying said graphene suspension comprises freeze-drying said suspension to form a graphene foam electrode.

36. The method of claim 1, wherein said electrode has an active material mass loading higher than 10 mg/cm².

37. The method of claim 1, wherein said electrode has an active material mass loading higher than 20 mg/cm².
